(19) United States
(12) Patent Application Publication
(10) Pub. No.: US 2026/0200229 A1
(43) Pub. Date: Jul. 16, 2026

(54) FLUSHING QUALITY DETERMINATION FOR PRINTHEADS

(71) Applicants: Walter F. Kailey, Frederick, CO (US); Ziling Zhang, Boulder, CO (US); Scott R. Johnson, Erie, CO (US)

(72) Inventors: Walter F. Kailey, Frederick, CO (US); Ziling Zhang, Boulder, CO (US); Scott R. Johnson, Erie, CO (US)

(73) Assignee: Ricoh Company, Ltd., Tokyo (JP)

(21) Appl. No.: 19/017,732

(22) Filed: Jan. 12, 2025

(51) Int. Cl. B41J 2/165; B41J 2/21

(52) U.S. Cl. CPC B41J 2/16579; B41J 2/1652; B41J 2/2142; B41J 2002/16573

(57) ABSTRACT

System, method, and software for determining flushing quality in an image forming apparatus. In an embodiment, a flushing quality manager is configured to perform at least one flushing quality check regarding a flushing operation of nozzles in at least one printhead. The at least one flushing quality check comprises identifying nozzle defects in the nozzles, computing a rate of nozzle defect formation based on the nozzle defects, and initiating a corrective action directed to modifying the flushing operation when the rate of nozzle defect formation exceeds a threshold.

### TECHNICAL FIELD

The following disclosure relates to the field of image formation, and in particular, to flushing of printheads used in image formation.

### BACKGROUND

Image formation is a procedure whereby one or more digital images are recreated by applying a print liquid (e.g., ink) to a printable medium, such as paper. Image forming apparatuses are used as printers, facsimile machines, copiers, plotters, or multi-functional devices, and may employ a liquid-ejection recording method, for example, an inkjet recording method. A liquid-ejection apparatus capable of performing a liquid-ejection recording method uses one or more printheads (also referred to as liquid-droplet ejection heads or recording heads) for ejecting liquid droplets onto a printable medium. Each individual printhead includes multiple tiny nozzles (e.g., hundreds of nozzles per inch) that are operable to discharge or jet ink (or another type of print liquid).

To maintain the condition of the nozzles of the printhead(s), an image forming apparatus may perform a dummy ejection operation referred to as flushing. In a flushing operation, liquid droplets that do not contribute to image formation (dummy ejection droplets) are ejected from the nozzles of the printhead(s) to prevent or reactivate misfiring or nonfiring nozzles. One issue is whether a flushing operation enabled within an image forming apparatus is sufficient, such as to maintain a desired print quality.

### SUMMARY

Embodiments described herein provide a flushing quality check or flushing quality determination for a flushing operation of an image forming apparatus. In an embodiment, a flushing quality manager or the like is configured to monitor nozzle defects (e.g., misfiring or nonfiring nozzles) in nozzles of a printhead(s), and initiate one or more corrective actions directed to changing or modifying the flushing operation based on the nozzle defects. For example, the flushing quality manager may adjust (e.g., automatically) a flushing setting based on the nozzle defects, may provide a warning indicating that a flushing setting is insufficient based on the nozzle defects, may provide a recommendation regarding an adjustment to a flushing setting, may abort a printing operation based on the nozzle defects, etc. One technical benefit is the quality of a flushing operation may be determined and appropriate adjustment made before print quality is perceptibly affected in an adverse manner.

In an embodiment (also referred to as aspects), an apparatus comprises a flushing quality manager comprising at least one processor and memory. The at least one processor is configured to cause the flushing quality manager at least to perform at least one flushing quality check regarding a flushing operation of nozzles in at least one printhead. The at least one flushing quality check comprises identifying nozzle defects in the nozzles, computing a rate of nozzle defect formation based on the nozzle defects, and initiating a corrective action directed to modifying the flushing operation when the rate of nozzle defect formation exceeds a threshold.

In an embodiment, a method comprises performing at least one flushing quality check regarding a flushing operation of nozzles in at least one printhead. The performing comprises identifying nozzle defects in the nozzles, computing a rate of nozzle defect formation based on the nozzle defects, and initiating a corrective action directed to modifying the flushing operation when the rate of nozzle defect formation exceeds a threshold.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a diagram of a print system in an illustrative embodiment.

FIG. 2 is a schematic diagram of an image forming apparatus in an illustrative embodiment.

FIGS. 3A-3B are block diagrams of a print engine(s) in illustrative embodiments.

FIGS. 4A-4B illustrate flushing operations in illustrative embodiments.

FIG. 5A is a block diagram illustrating a flushing controller in an illustrative embodiment.

FIG. 5B is a block diagram illustrating a flushing quality manager in an illustrative embodiment.

FIG. 6 illustrates flushing settings in an illustrative embodiment.

FIGS. 7A-7B illustrate flushing marks corresponding with flushing settings in an illustrative embodiment.

FIG. 8A is a flow chart illustrating a method of monitoring flushing operations in an illustrative embodiment.

FIG. 8B is a flow chart illustrating a method of generating nozzle defect data in an illustrative embodiment.

FIGS. 9A-9D are flow charts illustrating methods of monitoring flushing operations in illustrative embodiments.

FIGS. 10A-10C are block diagrams illustrating flushing quality checks in illustrative embodiments.

FIG. 11 is a block diagram illustrating an image forming apparatus that implements a nozzle inspection system in an illustrative embodiment.

FIGS. 12A-12C are flow charts illustrating methods of performing flushing quality checks in illustrative embodiments.

FIGS. 13A-13C are flow charts illustrating methods of performing flushing quality checks in illustrative embodiments.

FIG. 14 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

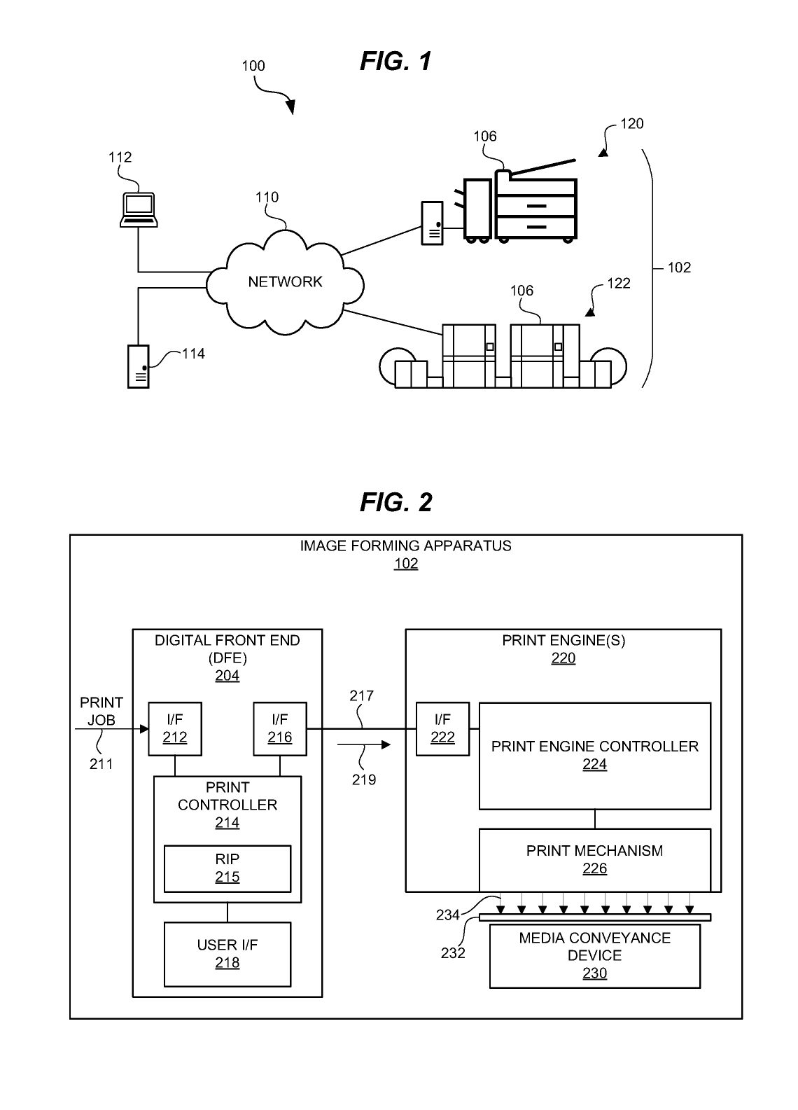

FIG. 1 is a diagram of a print system 100 in an illustrative embodiment. As one example in FIG. 1, print system 100 may include one or more image forming apparatuses 102, one or more client terminals 112 (e.g., a mobile device, a laptop, a personal computer (PC), etc.), and one or more management servers 114 (also referred to as a print server). As illustrated in FIG. 1, one or more of the devices of print system 100 are able to perform data communication with one another via a network 110. The network 110 may comprise, for example, a network including a local area network (LAN), a wide area network (WAN), such as the Internet, etc., and may comprise a wired network, a wireless network, or a network including both of a wired network and a wireless network.

An image forming apparatus 102 (also referred to as a printer 106 herein) may comprise an apparatus that performs image formation (printing) on a recording or printable medium by applying colorants or marking/recording material on the basis of print data. A printer 106 may comprise a cut-sheet printer 120, a continuous-form printer 122 that prints on a web of continuous-form media, a wide format printer, etc. A printer 106 as described herein may print at speeds of hundreds of pages or more per minute, where nozzle defects need to be quickly addressed to avoid large amounts of unacceptable printed pages.

The client terminal 112 is an information processing apparatus or end user device that generates a print job to be printed by a user and transmits the print job to a printer 106 or the management server 114. The management server 114 is a server apparatus that manages print jobs received from client terminals 112 and transmits the print jobs to printers 106.

Print system 100 may be configured for professional, commercial, production, or industrial printing. Commercial printing may be performed by Print Service Providers (PSP) or other providers that offer printing services to users/customers in exchange for monetary compensation. For example, a PSP may offer printing services for advertising or marketing materials, product manuals, books, invoices/bills, blueprints, mailings, etc. A PSP may own or operate a variety of printing equipment, referred to generally as a print shop. For example, a print shop may include one or more printers 106 and/or other print equipment (e.g., post-print devices, finishing devices, etc.).

FIG. 2 is a schematic diagram of an image forming apparatus 102 in an illustrative embodiment. Image forming apparatus 102 is a type of device that executes an image forming process (e.g., printing) on a recording or printable medium. In an embodiment, image forming apparatus 102 comprises a digital front end (DFE) 204 and one or more print engines 220. DFE 204 is an information processing apparatus configured to accept a print job 211, and convert the print job 211 into a suitable format for a print engine(s) 220. More particularly, DFE 204 generates print data 219 by a raster image processor (RIP) engine on the basis of the print job 211, and transmits the print data 219 to the print engine(s) 220. Print data 219 may additionally or alternatively include test chart data independent of print job 211 as will be explained below. In an embodiment, DFE 204 may be on-ground or on-premises with the print engine(s) 220. In general, “on-premises” means that the infrastructure exists on-site in contrast to being hosted off-site. DFE 204 may be implemented on a separate (on-premises) platform from the print engine(s) 220, or may be integrated on a platform of the print engine(s) 220. In an embodiment, DFE 204 may communicate with the print engine(s) 220 over network 110.

DFE 204 includes an Input/Output (I/O) interface 212, a print controller 214, and a print engine interface 216, and may also include a user interface 218 (also referred to as an operator console). I/O interface 212 comprises an apparatus, device, circuitry, means, and/or other component configured to receive a print job 211 from a source, such as a client terminal 112, a management server 114, etc. I/O interface 212 may be considered a network interface in some embodiments. The print job 211 comprises one or more print files (also referred to as job files or vector files) formatted with a Page Description Language (PDL), such as PostScript, Printer Command Language (PCL), Intelligent Printer Data Stream (IPDS), etc. The print job 211 may also comprise a job ticket containing instructions, requirements, and/or other control information for processing and/or printing a print job, such as a Job Definition Format (JDF) job ticket. Print controller 214 comprises an apparatus, device, circuitry, means, and/or other component configured to transform the print job 211 into print data 219 comprising one or more digital images (also referred to as raster images or halftone images) that may be used by print engine(s) 220 to mark a printable medium 232 with ink or another recording material, marking material, print liquid, etc. In an embodiment, print controller 214 includes a Raster Image Processor (RIP) 215 that translates or rasterizes the print job 211 to generate the digital images that a printer can understand and print. A digital image comprises a two-dimensional array of pixels or dots, also referred to as a bitmap (e.g., halftone bitmap). Whereas the print file(s) of the print job 211 in PDL format is a high-level description of the content (e.g., text, graphics, pictures, etc.), a digital image defines a pixel value or color value for each pixel in a display space. Print engine interface 216 comprises an apparatus, device, circuitry, means, and/or other component configured to communicate with print engine(s) 220, such as to transmit digital images to print engine(s) 220. Print engine interface 216 may be communicatively coupled to print engine(s) 220 via one or more communication links 217 (e.g., a fiber link, a bus, a communication cable, etc.), and is configured to transfer the digital images to print engine(s) 220. User interface 218 is a component configured to interact with a human operator (also referred to as a printer operator). A human operator may access user interface 218 to view status indicators or updates, view or manipulate settings, schedule print jobs, etc.

Print engine(s) 220 includes a DFE interface 222, a print engine controller 224, and a print mechanism 226 (or multiple print mechanisms). DFE interface 222 comprises an apparatus, device, circuitry, means, and/or other component configured to interact with DFE 204, such as to receive print data 219 from DFE 204. Print engine controller 224 comprises an apparatus, device, circuitry, means, and/or other component configured to process the print data 219 (e.g., the digital images) received from DFE 204, and provide control signals to print mechanism 226. Print mechanism 226 is an image formation device (or devices) that marks the printable medium 232 with a print liquid 234. Print mechanism 226 may be configured for variable droplet or dot size to reproduce multiple intensity levels. Printable medium 232 comprises any type of material suitable for printing upon which print liquid 234 is applied, such as paper (web or cut-sheet), plastic, card stock, transparent sheets, cloth, etc. In an embodiment, print mechanism 226 may include one or more printheads that are configured to jet or eject droplets of a print liquid 234, such as ink (e.g., water-based, solvent-based, oil-based, or UV-curable), through a plurality of orifices or nozzles. The orifices or nozzles may be grouped according to liquid types (e.g., colors such as Cyan (C), Magenta (M), Yellow (Y), Key black (K) or formulas such as for pre-coat, image and protector coat, etc.), which may be referred to as color planes. Media conveyance device 230 may be configured to move printable medium 232 relative to print mechanism 226. In other embodiments, portions of print mechanism 226 may be configured to move relative to printable medium 232. Image forming apparatus 102 may include various other components not specifically illustrated in FIG. 2.

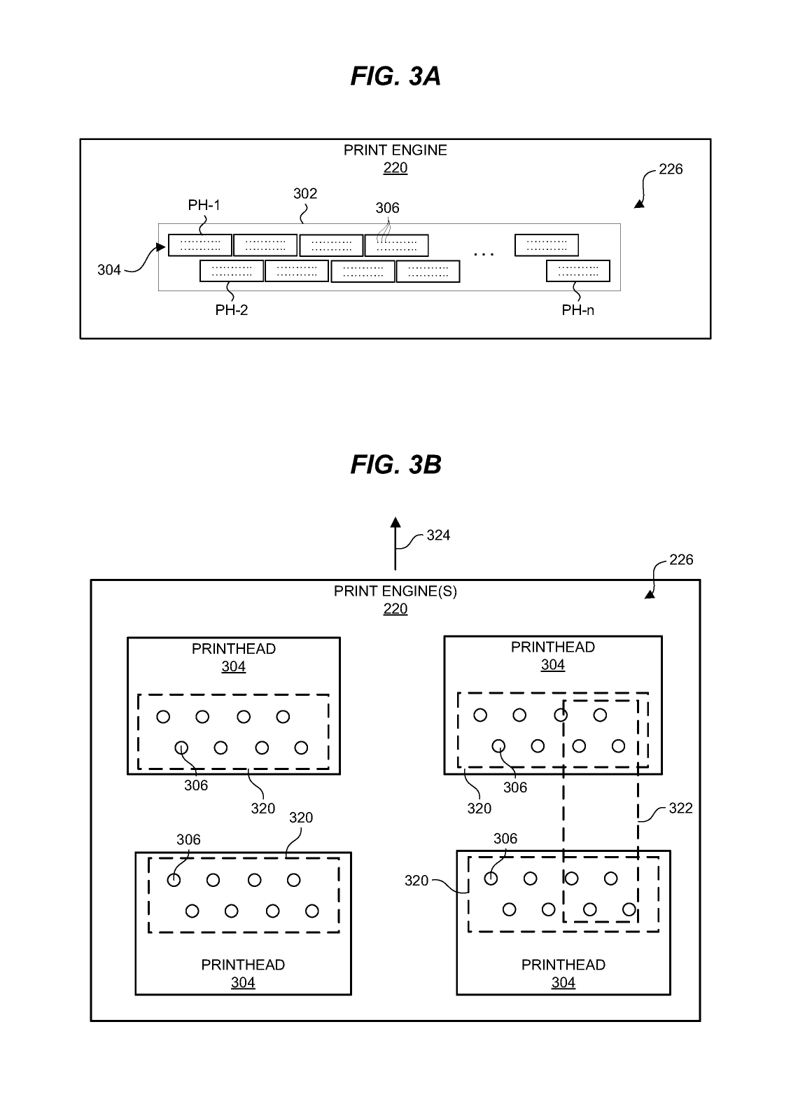

FIGS. 3A-3B are block diagrams of a print engine(s) 220 in illustrative embodiments. In FIG. 3A, a print mechanism 226 of a print engine 220 may include an array 302 (or multiple arrays) of printheads 304 (e.g., PH-1, PH-2, …, PH-n). Each printhead 304 is configured to eject or jet droplets of a print liquid 234, such as ink, through a plurality of nozzles 306. Typically, the nozzles 306 of a printhead 304 are arranged in one or more rows so that jetting from the nozzles 306 causes formation of characters, symbols, images, layers of an object, etc., on printable medium 232. Although two rows of nozzles 306 per printhead 304 are illustrated in FIG. 3A, nozzles 306 may be arranged in a single row or more than two rows in other examples.

In FIG. 3B, an image forming apparatus 102 may support a single color plane 320 or multiple color planes 320 (e.g., C, M, Y, K). Each print engine 220 may process print data 219 for one or a plurality of color planes 320 and control one or a plurality of printheads 304 based on the print data 219. Each printhead 304 includes an array of nozzles 306 that eject droplets of a print liquid 234 for printing. The nozzles 306 of each printhead 304 may be assigned to one color plane 320 or divided between a plurality of color planes 320.

One issue with image formation using liquid-droplet ejection printheads is misfiring or nonfiring nozzles. For example, nozzles 306 that are excessively idle or inactive may become clogged or partially-clogged, which results in nozzle defects or abnormalities, such as jet-out defects, deviated-jet defects, nozzle failures, etc. To address these issues, an image forming apparatus 102 may have a flushing function or utility to prevent or reactivate misfiring or nonfiring nozzles. For a flushing operation (also referred to generally as flushing), an image forming apparatus 102 performs a dummy ejection operation where liquid droplets that do not contribute to image formation (dummy ejection droplets) are ejected or jetted from one or more nozzles 306 of the printhead(s) 304. One technical benefit is the flushing operation prevents or reactivates misfiring or nonfiring nozzles to improve print quality.

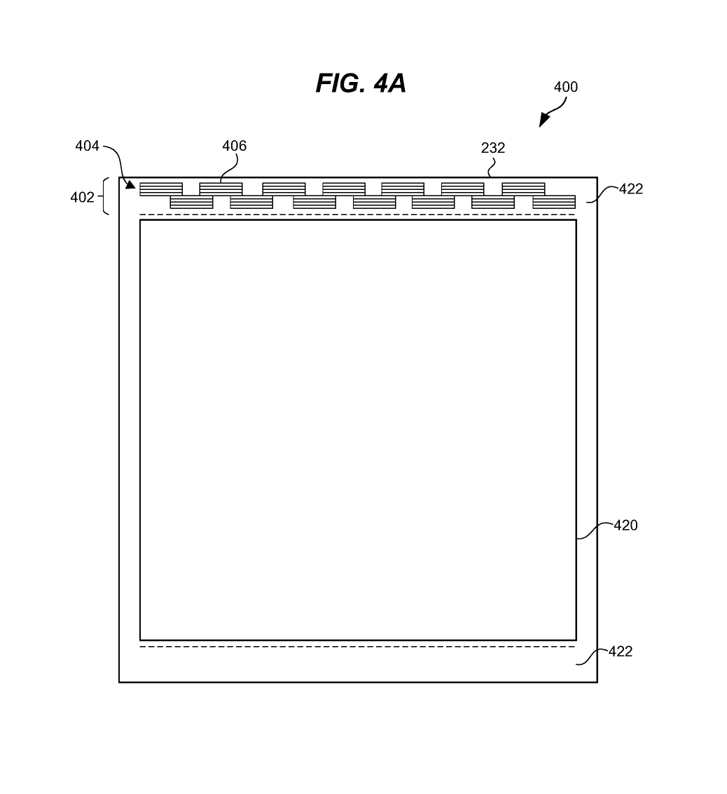

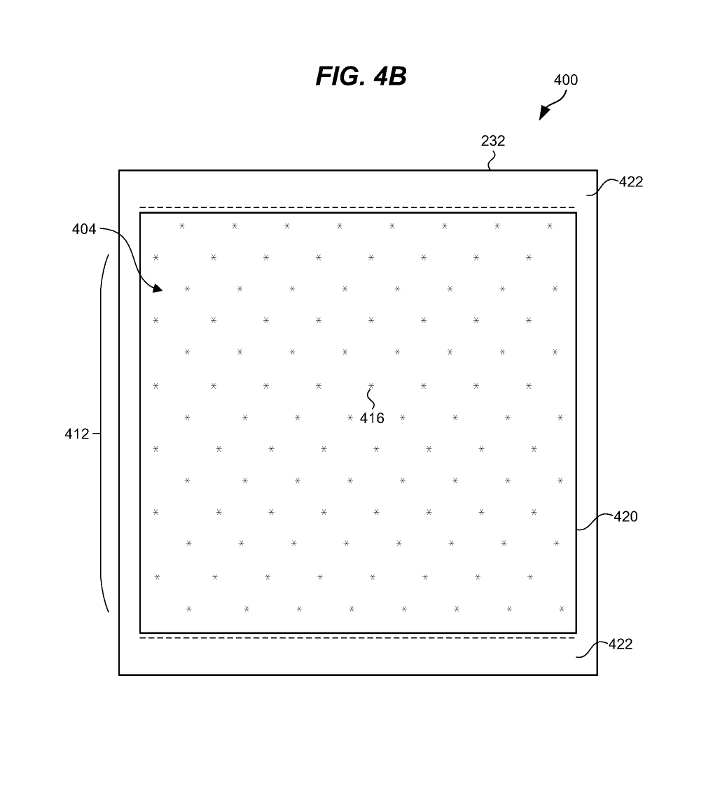

Flushing operations may vary depending on the configuration of an image forming apparatus 102. For example, some image forming apparatuses 102 may perform a flushing operation by jetting print liquid 234 into a collection receptacle (i.e., containing an absorption element, such as a sponge). Some image forming apparatuses 102 may perform a flushing operation by jetting flush marks on a printable medium 232. FIGS. 4A-4B illustrate flushing operations 400 in illustrative embodiments. In FIG. 4A, a flushing operation 400 may comprise a line flushing operation 402 where flush marks 404 output by printheads 304 comprise one or more flush lines 406. In the example of FIG. 4A, a printable medium 232 (or a sheet or sheetside of a printable medium 232) has an image formation area 420 and one or more non-image formation areas 422. Flush lines 406 are often printed on the printable medium 232 on non-image formation areas 422 at or near page boundaries (e.g., top or bottom of a page margin) and outside of the image formation area 420. A line flushing operation 402 is beneficial in that the dummy ejection may be intense or forceful, although the portions of the printable medium 232 on which the flush lines 406 are printed will likely need to be cut and wasted.

In FIG. 4B, a flushing operation 400 may comprise a star flushing operation 412 where flush marks 404 output by the printheads 304 comprise one or more star flush patterns 416. The star flush patterns 416 (also referred to as star patterns) are a less visible size of liquid droplets for dummy ejection on an image formation area 420 of the printable medium 232. In other words, star flush patterns 416 are typically printed on a printable medium 232 as small dots or “stars” comingled with a printed image(s) on an image formation area 420. A star flushing operation 412 is beneficial in that the star flush patterns 416 are formed on an image formation area 420 and not on a wasted portion of a printable medium 232. Although the effectiveness of the flushing may be reduced due to the less intense dummy ejection of small droplets formed on the image formation area 420, star flushing can compensate for this with more continuous emission of these droplets.

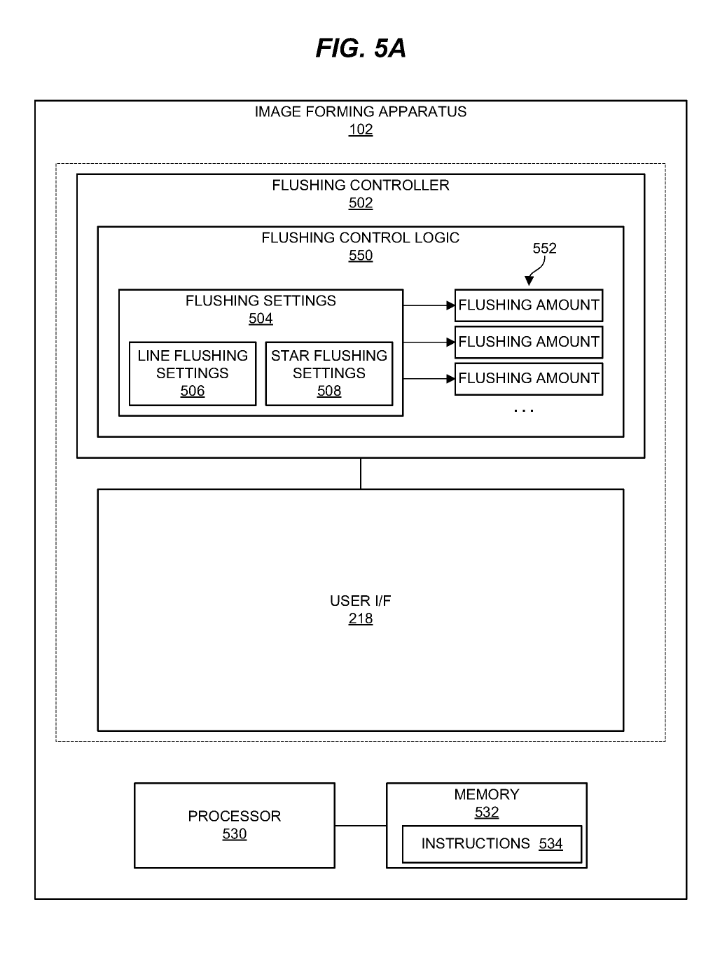

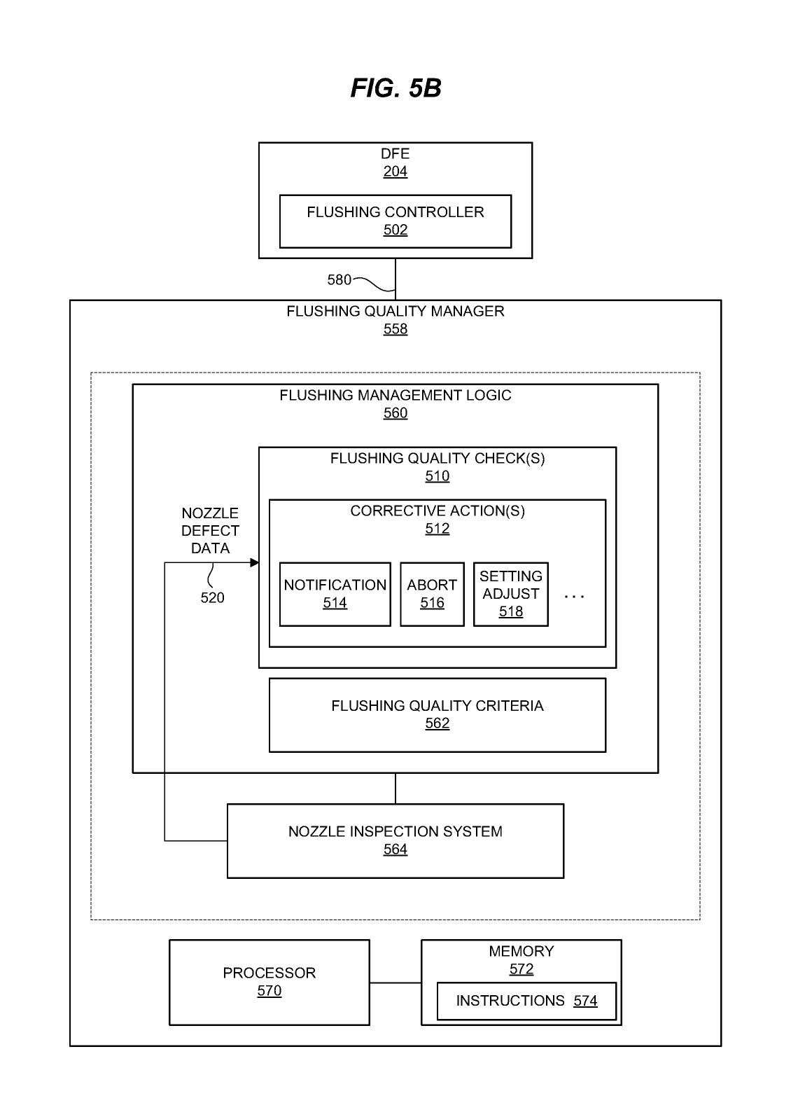

FIG. 5A is a block diagram illustrating a flushing controller 502 in an illustrative embodiment. Flushing controller 502 comprises an apparatus, device, circuitry, means, and/or other component configured to control, supervise, or perform one or more flushing operations 400 for an image forming apparatus 102. Flushing controller 502 may be implemented in the print controller 214 of the image forming apparatus 102 (see FIG. 2), or may be implemented as a separate device/component.

Flushing controller 502 comprises flushing control logic 550 configured to control or perform flushing operations 400. For example, the flushing control logic 550 may send control signals, instructions, commands, modified digital images, etc., to a print engine(s) 220 to jet dummy droplets from one or more nozzles 306 of the printhead(s) 304. The frequency of a flushing operation 400 may be configurable in the flushing control logic 550. For example, the flushing control logic 550 may provide a selection of flushing operation cycles for an image forming apparatus 102, where the frequency of a flushing operation 400 is specified. Alternatively, the frequency of a flushing operation 400 may be predefined.

A flushing operation 400 may have variable flushing settings 504. In general, the flushing settings 504 may represent different flushing amounts 552 in terms of the amount of print liquid 234 jetted, the velocity of jetting, etc., in a flushing operation 400. The flushing settings 504 may be selectable by a printer operator or the like, such as through a user interface 218. In an embodiment, the flushing settings 504 may comprise line flushing settings 506, star flushing settings 508, and/or other types of flushing settings. For example, the flushing settings 504 may range from thin line flushing to thick line flushing for a line flushing operation 402, from light star patterns to heavy star patterns for a star flushing operation 412, etc. Flushing control logic 550 may receive instructions to adjust flush settings 504 from flushing management logic 560 as will be explained below.

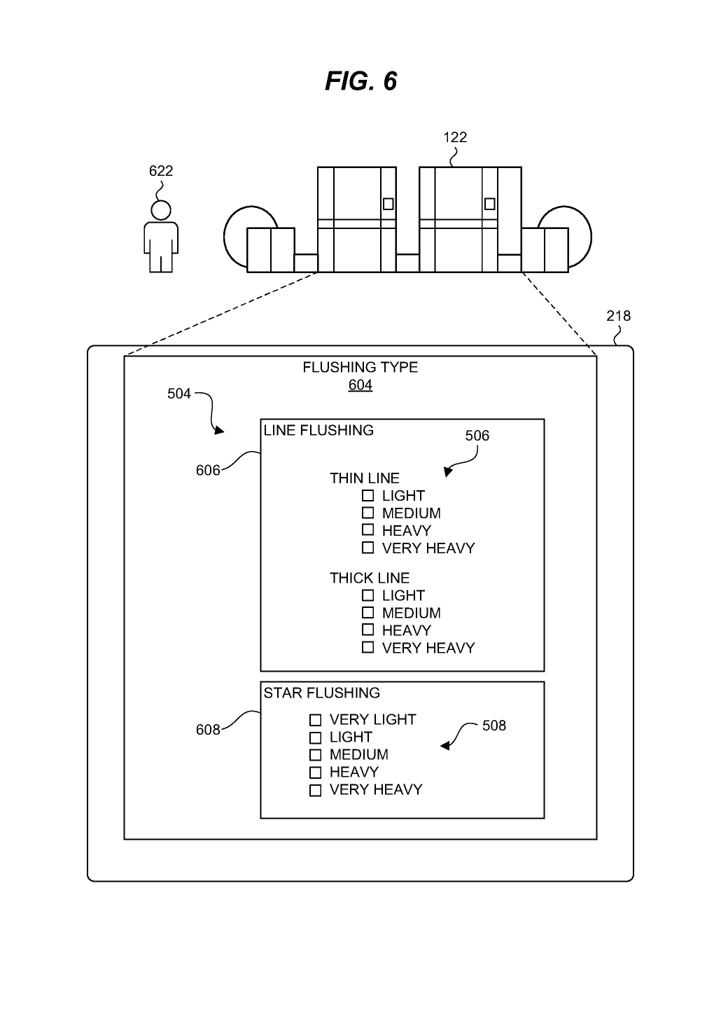

FIG. 6 illustrates flushing settings 504 in an illustrative embodiment. In FIG. 6, a user interface 218 of a continuous-form printer 122 is shown as an example. The user interface 218 is configured to display flushing settings 504 that are configurable on the continuous-form printer 122, and selectable by a printer operator 622. The flushing settings 504 may include one or more flushing types 604, such as line flushing type 606, star flushing type 608, etc. The line flushing type 606 may include multiple line flushing settings 506 of different flushing amounts 552 or different (e.g., increasing) density levels (i.e., amount of print liquid 234 per surface area of printable medium 232) for flush marks 404. For example, the line flushing settings 506 may include thin line flushing of increasing density levels (e.g., “light”, “medium”, “heavy”, and “very heavy”), thick line flushing of increasing density levels (e.g., “light”, “medium”, “heavy”, and “very heavy”), etc. The star flushing type 608 may include multiple star flushing settings 508 of different flushing amounts 552 or different (e.g., increasing) density levels for flush marks 404 (e.g., “very light”, “light”, “medium”, “heavy”, and “very heavy”).

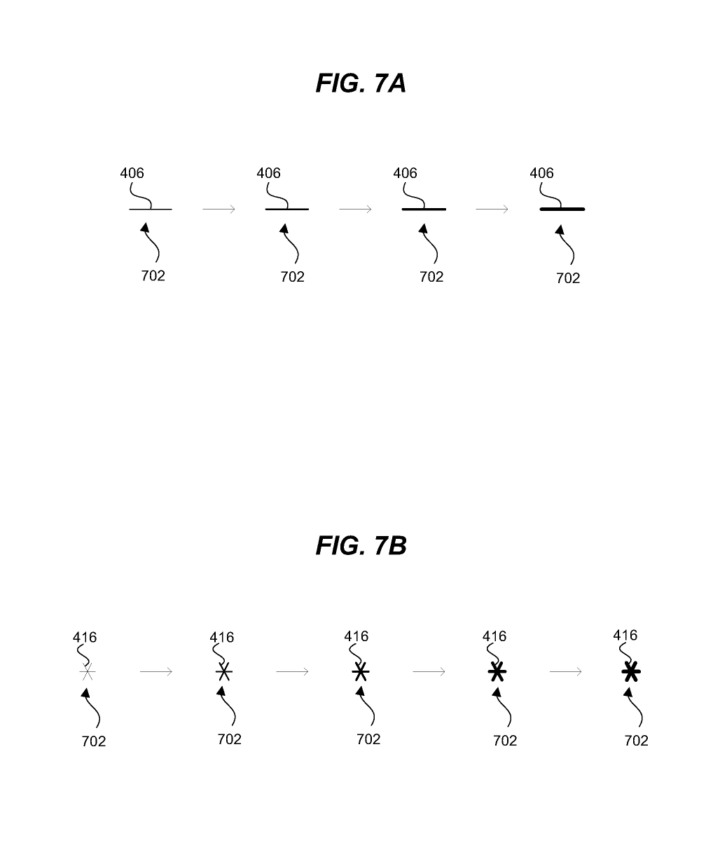

FIGS. 7A-7B illustrate flushing marks 404 corresponding with flushing settings 504 in an illustrative embodiment. FIG. 7A illustrates flush lines 406 corresponding with line flushing settings 506 (e.g., “light”, “medium”, “heavy”, and “very heavy”). The flush lines 406 of the different line flushing settings 506 have different density levels 702. For example, the flush lines 406 have increasing density levels 702 from the lowest level (e.g., “light”) to the highest level (e.g., “very heavy”). FIG. 7B illustrates star flush patterns 416 corresponding with star flushing settings 508 (e.g., “very light”, “light”, “medium”, “heavy”, and “very heavy”). The star flush patterns 416 of the different star flushing settings 508 have different density levels 702. For example, the star flush patterns 416 have increasing density levels 702 from the lowest level (e.g., “very light”) to the highest level (e.g., “very heavy”).

FIG. 5B is a block diagram illustrating a flushing quality manager 558 in an illustrative embodiment. Flushing quality manager 558 (also referred to as a flushing sentinel) comprises an apparatus, device, circuitry, means, and/or other component configured to oversee or monitor flushing operations 400 for an image forming apparatus 102. In an embodiment, the flushing quality manager 558 may be implemented in a separate device/component from the DFE 204, which is communicatively coupled to the DFE 204 and/or flushing controller 502. In an embodiment, the flushing quality manager 558 may be implemented in the print controller 214 of the image forming apparatus 102.

Flushing quality manager 558 comprises flushing management logic 560 configured to perform one or more flushing quality checks 510 to determine the effectiveness of flushing operations 400 for an image formation apparatus 102. For example, selection of a flushing setting 504 may be a manual choice by a printer operator 622. The printer operator 622 may have guidelines to follow (e.g., from a printer manufacturer), but an inadequate flushing setting 504 may be selected in marginal cases, by human error, etc. When the selected flushing setting 504 is too low, nozzle defects (also referred to as jetting defects or ejection defects) may begin to appear that are not visually perceptible to a printer operator 622 or the like. When the selected flushing setting 504 is too high, there may also be adverse effects, such as print liquid 234 is wasted, print quality may be adversely affected in the case of star flushing, etc. One technical benefit is the flushing management logic 560 monitors the quality of flushing operations 400 to identify nozzle defects that are not visually perceptible to a printer operator 622 before print quality is negatively affected, while limiting waste of resources (e.g., print liquid 234, printable medium 232, etc.).

As will be described in further detail below, the flushing management logic 560 operates using nozzle defect data 520, which is information indicating defects in the jetting operation of nozzles 306 (e.g., misfiring or nonfiring nozzles). For example, nozzle defect data 520 may indicate directly or be processed to determine a number of nozzles 306 experiencing a defect, which nozzles 306 are experiencing a defect, which sections of image forming apparatus 102 the defective nozzles belong to (e.g., which nozzles 306 of a printhead(s) 304, which nozzles of a color plane 320, which nozzles of a region, etc.), and/or other information. The flushing management logic 560 processes the nozzle defect data 520 to determine the health of the nozzles 306. When a certain number, percentage, or some other measure of the nozzles 306 are “healthy”, the flushing management logic 560 may determine that the present flushing setting 504 is adequate or optimal. When a certain number, percentage, or some other measure of the nozzles 306 are “unhealthy”, the flushing management logic 560 may determine that the present flushing setting 504 is inadequate and may initiate one or more corrective actions 512. For example, the flushing management logic 560 may provide or issue a notification 514 (e.g., warning, recommendation, etc.) such as to the printer operator 622, may provide or issue an abort signal 516 to abort a printing operation, may perform a setting adjustment 518 to adjust the present flushing setting 504, and/or take another corrective action 512. The flushing management logic 560 may be provisioned or pre-configured with rules, policies, or criteria (referred to generally as flushing quality criteria 562) to determine what corrective action 512 to take.

Flushing quality manager 558 may further comprise a nozzle inspection system 564. Nozzle inspection system 564 comprises an apparatus, device, circuitry, means, and/or other component configured to detect defects in jetting or ejection of nozzles 306. In general, the jetting of nozzles 306 is so small and/or the nozzles 306 are so closely spaced that a human cannot practically perceive jetting or ejection defects of nozzles 306. A goal of flushing quality management is to detect insufficient flushing before nozzle defects become so prevalent that image quality is perceivable by a human, as this unfortunately results in wasted printed output. Thus, a nozzle inspection system 564 may be used to detect defects in jetting or ejection of nozzles 306. In an embodiment, the nozzle inspection system 564 may be configured to examine printed output to determine which nozzles 306 of one or more printheads 304 are defective. The printed output examined may be specially designed for aiding detection of nozzle defects. For example, the print controller 214 may instruct a print engine(s) 220, one or more printheads 304, certain nozzles 306, etc., to print a test chart on the printable medium 232 based on test chart print data. The nozzle inspection system 564 may image the printed test chart, such as with a camera, scanner, densitometer, spectrophotometer or other suitable component for acquiring images of printed content, and analyze the image of the printed test chart to detect nozzle defects. The nozzle inspection system 564 may compare the test chart print data with the image of the test chart to determine whether there are any discrepancies that indicate jetting or ejection errors. The nozzle inspection system 564 may generate nozzle defect data 520, and provide the nozzle defect data 520 to the flushing management logic 560. In another embodiment, the nozzle inspection system 564 may be configured to examine the nozzles directly for defects.

The flushing controller 502 and/or flushing quality manager 558 may be implemented on hardware platforms comprised of analog and/or digital circuitry. The flushing controller 502 may be implemented on a processor 530 that executes instructions 534 stored in memory 532. Processor 530 comprises an integrated hardware circuit configured to execute instructions 534 to provide the functions of the flushing controller 502. Likewise, the flushing quality manager 558 (or a portion thereof) may be implemented on a processor 570 that executes instructions 574 stored in memory 572. Processor 570 comprises an integrated hardware circuit configured to execute instructions 574 to provide the functions of the flushing quality manager 558. A processor 530/570 may comprise a set of one or more processors or may comprise a multi-processor core, depending on the particular implementation. A memory 532/572 may comprise a non-transitory computer readable medium for data, instructions, applications, etc., and is accessible by a processor 530/570. A memory 532/572 is a hardware storage device capable of storing information on a temporary basis and/or a permanent basis. A memory 532/572 may comprise a random-access memory, or any other volatile or non-volatile storage device.

The flushing controller 502 and/or the flushing quality manager 558 may comprise various other components not specifically illustrated in FIGS. 5A-5B.

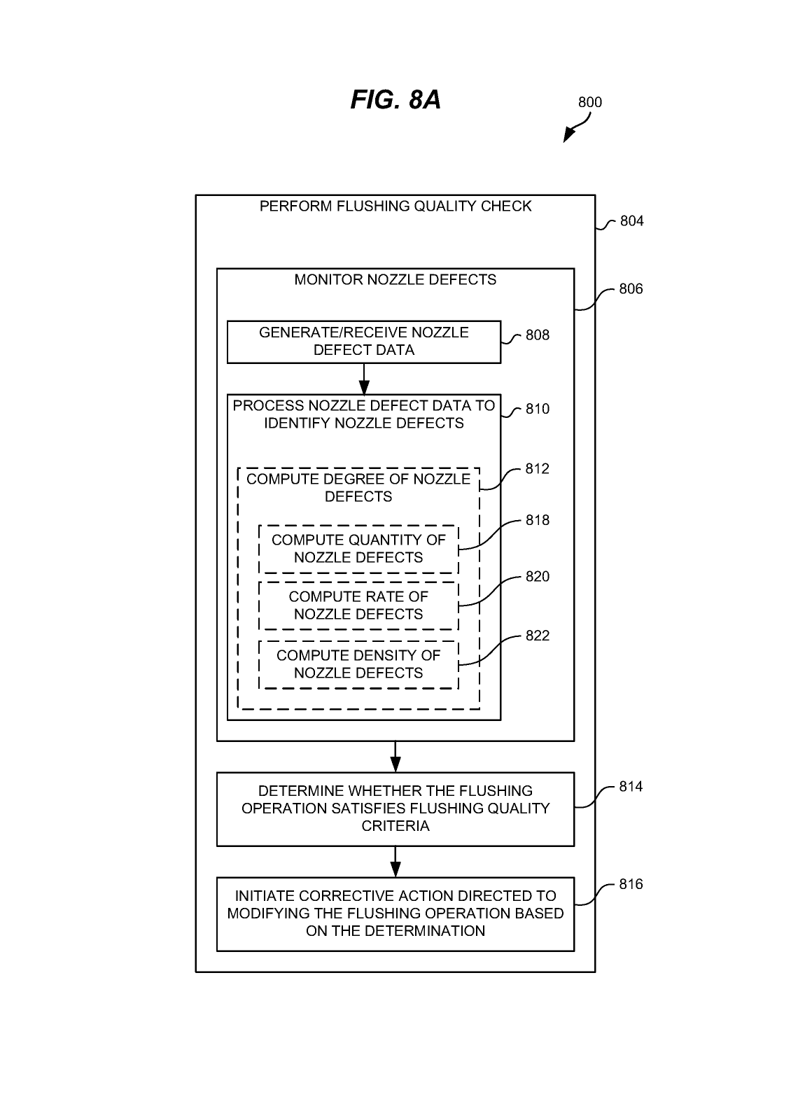

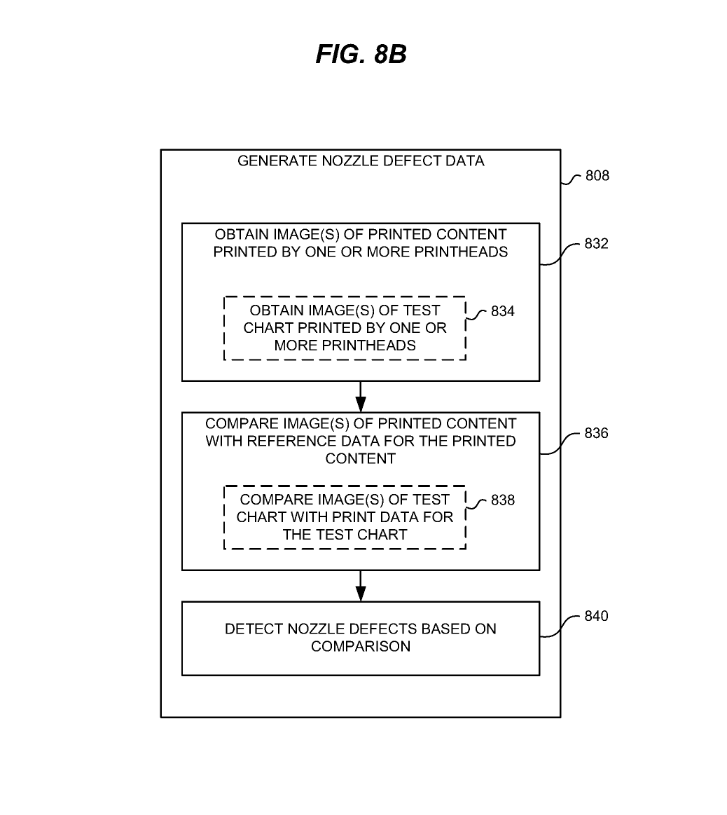

FIG. 8A is a flow chart illustrating a method 800 of monitoring flushing operations 400 in an illustrative embodiment. The steps of method 800 will be described with reference to the flushing quality manager 558 in FIG. 5B, but those skilled in the art will appreciate that the methods (also referred to as processes) described herein may be performed in other systems or devices. Also, the steps of the flow charts described herein are not all inclusive and may include other steps not shown, and the steps may be performed in an alternative order.

One assumption is that the image forming apparatus 102 performs a print operation for one or more print jobs 211. For example, the print controller 214 (see FIG. 2) may instruct the print engine(s) 220 to print digital images based on the print data 219 sent to the print engine(s) 220, and the printhead(s) 304 of the print engine(s) 220 jets print liquid 234 onto a printable medium 232 accordingly. During or between print operations, the flushing control logic 550 of the flushing controller 502 performs, initiates, instructs, or controls a flushing operation 400. The flushing operation 400 is performed based on a selected one of the flushing settings 504. After one or more instances or occurrences of the flushing operation 400, the flushing quality manager 558 performs, controls, or initiates a flushing quality check 510 (step 804). For the flushing quality check 510, the flushing quality manager 558 monitors nozzle defects of the nozzles 306 of the printhead(s) 304 in jetting (step 806). To monitor nozzle defects, the flushing quality manager 558 may generate or receive nozzle defect data 520 for the nozzles 306 of the printhead(s) 304 (step 808), and process the nozzle defect data 520 to identify nozzle defects that are detected or identified (step 810).

The flushing quality manager 558 may also compute or calculate a degree, measure, or metric of the nozzle defects (optional step 812). A degree of nozzle defects is some amount that quantifies the nozzle defects or is indicative of a condition of the nozzles 306 based on the nozzle defects. For example, the flushing quality manager 558 may compute a number or quantity of nozzle defects (optional step 818), compute a rate of nozzle defect formation (optional step 820), compute a localized density of nozzle defects within a section of a print mechanism 226, such as an individual printhead, a printhead array, a color plane, a region (optional step 822), etc. The flushing quality manager 558 determines whether the flushing operation 400 (i.e., according to the present flushing setting 504) satisfies flushing quality criteria 562 in terms of the nozzle defects (step 814). More particularly, the flushing quality manager 558 may compare the degree of nozzle defects to the flushing quality criteria 562 to determine whether the flushing operation 400 satisfies the flushing quality criteria 562. The flushing quality manager 558 initiates or performs one or more corrective actions 512 directed to changing or modifying (e.g., automatically) the flushing operation 400 (or a flushing setting 504 of the flushing operation 400) based on the determination (step 816). More particularly, the flushing quality manager 558 initiates one or more corrective actions 512 based on the degree of nozzle defects, such as when the number of nozzle defects exceeds a threshold, when a rate of nozzle defect formation exceeds a threshold, etc. One technical benefit is the quality of a flushing operation 400 may be determined and appropriate adjustment made before print quality is perceptibly affected.

FIG. 8B is a flow chart illustrating a method of generating nozzle defect data 520 in an illustrative embodiment. In an embodiment, the flushing quality manager 558 may implement a nozzle inspection system 564 to generate the nozzle defect data 520 (see also, FIG. 5B). To generate the nozzle defect data 520, the nozzle inspection system 564 obtains an image (or multiple images) of printed content printed with one or more printheads 304 (step 832). For example, the nozzle inspection system 564 may obtain an image (or multiple images) of a printed test chart printed with one or more printheads 304 (optional step 834). The nozzle inspection system 564 analyzes the image(s) of the printed content such as by comparing the image(s) of the printed content to reference data for the printed content (i.e., digital or raster image of the content) (step 836). For example, the nozzle inspection system 564 may compare an image(s) of a printed test chart to reference data for the test chart (i.e., digital or raster image of the test chart, also referred to as test chart print data) (optional step 838). The nozzle inspection system 564 detects nozzle defects based on the comparison (step 840). For example, by comparing the original digital image of the content sent by the print controller 214 to the print mechanism 226 for printing, with the image of the printed content, the nozzle inspection system 564 is able to determine which nozzles jetted correctly and which did not. Thus, the nozzle inspection system 564 is able to detect nozzle defects in one or more of the nozzles.

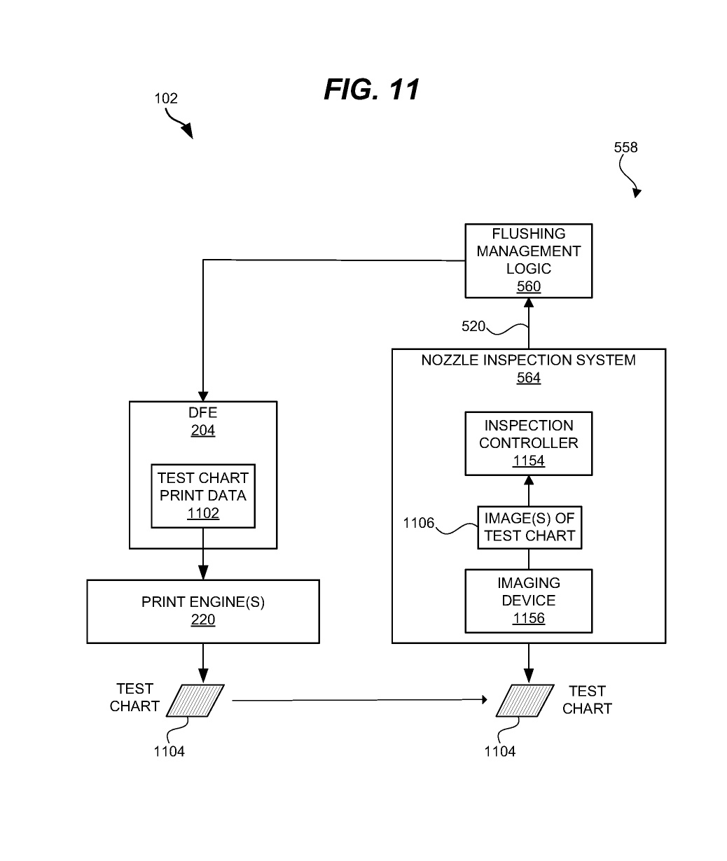

FIG. 11 is a block diagram illustrating an image forming apparatus 102 that implements a nozzle inspection system 564 in an illustrative embodiment. To verify that nozzles 306 of a print engine(s) 220, one or more printheads 304, etc., are operating correctly, the print controller 214 (see FIG. 2) may instruct a print engine(s) 220 or a portion thereof to print a test chart 1104 based on test chart print data 1102 onto a printable medium 232 that may be analyzed by the nozzle inspection system 564 downstream from the print engine(s) 220. The nozzle inspection system 564 may include an inspection controller 1154 and one or more imaging device(s) 1156. An imaging device 1156 may comprise a camera, scanner, densitometer, spectrophotometer, or other suitable component for acquiring images or a representation of printed content. The test chart 1104 may be printed on the printable medium 232 in non-image formation regions.

The imaging device 1156 obtaining an image(s) 1106 of the printed test chart 1104, and the inspection controller 1154 analyzes the image(s) 1106 for nozzle defects (i.e., looks for jetting defects of the nozzles 306). For example, the inspection controller 1154 may be configured to determine which printheads 304 or nozzles 306 printed the defects based on the location of the defects in the printed test chart 1104. The print controller 214 may transmit the test chart print data 1102 corresponding to test chart 1104 to the nozzle inspection system 564 for comparison to an image(s) 1106 of the printed test chart 1104 to determine whether there are any discrepancies that indicate printing errors, and the nozzle inspection system 564 may report (e.g., transmit) nozzle defect data 520 based on the comparison.

Although one type of nozzle inspection system 564 is illustrated in FIG. 11, other types of nozzle inspection systems 564 are considered herein. For example, a nozzle inspection system 564 may include a line scanner or the like configured to inspect nozzle jetting in real-time to generate the nozzle defect data 520. Regardless of the type of nozzle inspection system 564, the flushing management logic 560 receives nozzle defect data 520 indicating any nozzle defects detected in nozzles 306 of one or more printheads 304 for one or more color planes 320. It is noted that a nozzle inspection system 564 may be incorporated in the same platform as the image forming apparatus 102, or may be implemented on a separate platform downstream from the image forming apparatus 102.

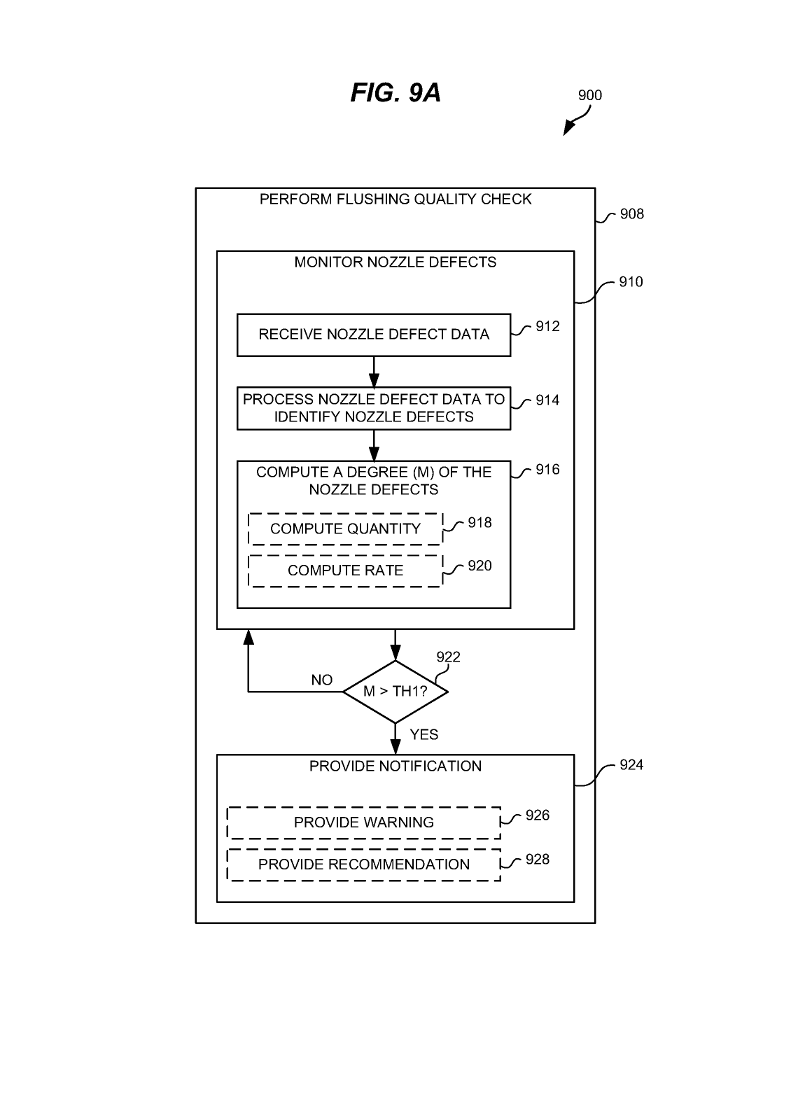

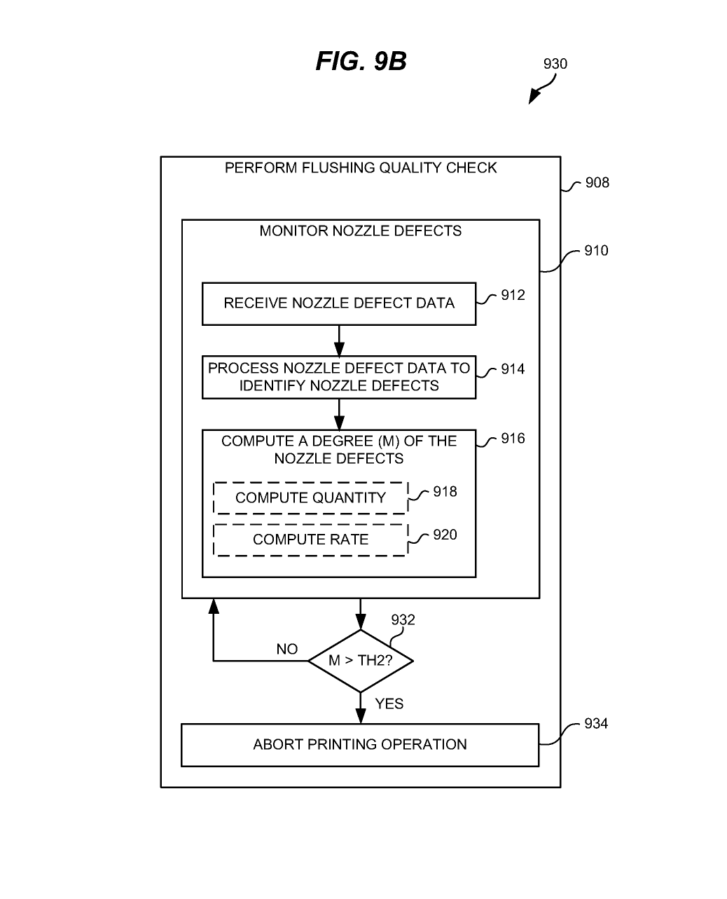

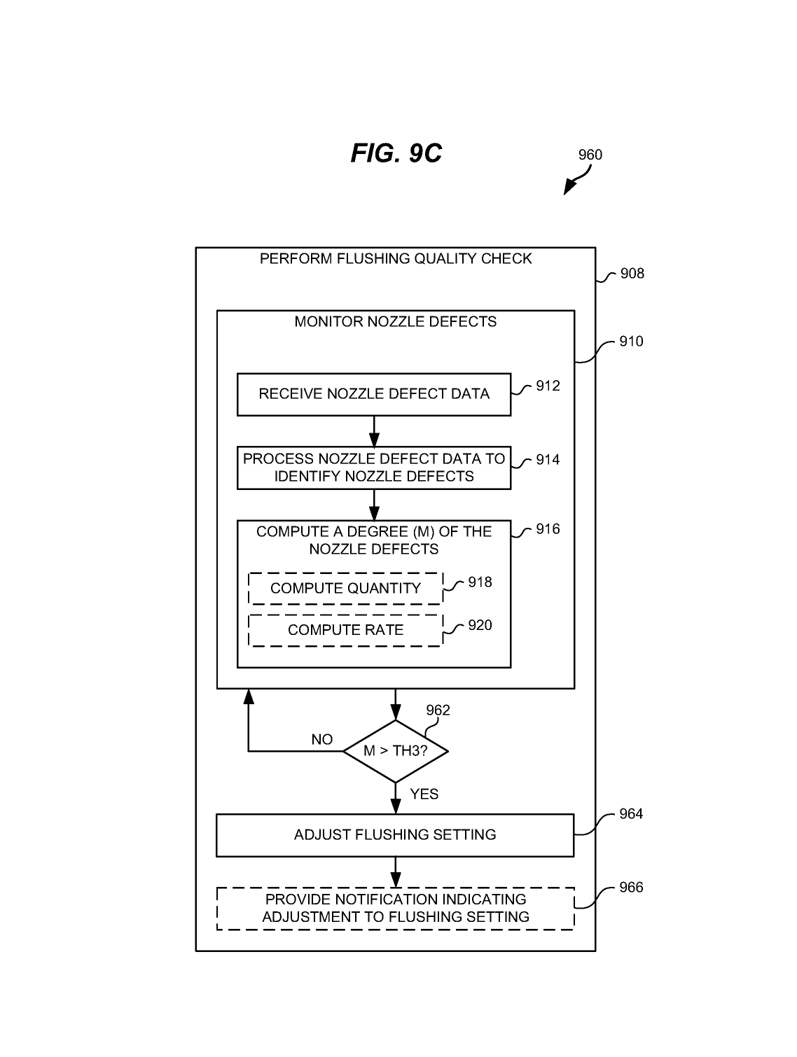

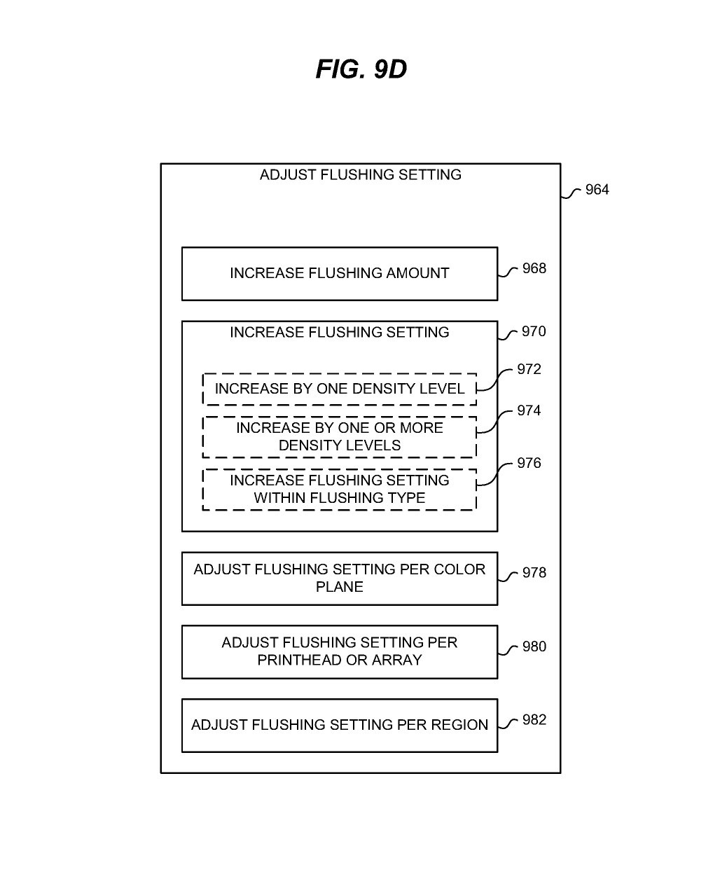

FIGS. 9A-9D are flow charts illustrating methods 900/930/960 of monitoring flushing operations 400 in illustrative embodiments. The steps of the methods 900/930/960 will be described with reference to the flushing quality manager 558 in FIG. 5B, but those skilled in the art will appreciate that the methods described herein may be performed in other systems or devices.

FIG. 9A illustrates a method 900 where the flushing management logic 560 provides a notification 514 when a degree of nozzle defects becomes excessive according to the flushing quality criteria 562 (i.e., exceeds a threshold). One assumption is that the image forming apparatus 102 performs a print operation for one or more print jobs 211. For example, the print controller 214 (see FIG. 2) may instruct the print engine(s) 220 to print digital images based on the print data 219 sent to the print engine(s) 220, and the printhead(s) 304 of the print engine(s) 220 jets print liquid 234 onto a printable medium 232 accordingly. During or between print operations, the flushing control logic 550 performs, initiates, or controls one or more flushing operations 400. For example, the flushing control logic 550 may control a line flushing operation 402, a star flushing operation 412, or another type of flushing not specifically illustrated. The flushing operation(s) 400 is performed according to the flushing setting 504 presently selected from the variable flushing settings 504. In a flushing operation 400, for example, the flushing control logic 550 may modify the print data 219 sent to the print engine(s) 220 to add dummy ejection data (e.g., firing or jetting instructions indicating a size of dummy droplets to eject, a location to jet the dummy droplets, etc.). The print engine(s) 220 will therefore cause the nozzles 306 to jet print liquid 234 based on the dummy ejection data, which is referred to as flushing.

After one or more instances or occurrences of the flushing operation 400, the flushing management logic 560 performs or initiates a flushing quality check 510 (step 908). For the flushing quality check 510, the flushing management logic 560 monitors nozzle defects of the nozzles 306 of the printhead(s) 304 in jetting (step 910). For example, the flushing management logic 560 may receive nozzle defect data 520 from a nozzle inspection system 564 or the like (step 912), and process the nozzle defect data 520 to identify nozzle defects that are detected (step 914). The flushing management logic 560 computes, calculates, or determines a degree (M) of nozzle defects (step 916). In an embodiment, the flushing management logic 560 may compute a number or quantity of nozzle defects over a time period, a length of printable medium 232, a number of sheets of printable medium 232, etc. (optional step 918). In an embodiment, the flushing management logic 560 may compute a rate of nozzle defect formation (or nozzle defect creation) over a time period, a length of printable medium 232, a number of sheets of printable medium 232, etc. (optional step 920). The degree (M) of nozzle defects may be for a print engine 220, an array 302 of printheads 304, a color plane 320, an individual printhead 304, a region 322 or area of a print engine 220, an array 302, a printhead 304, along multiple printheads 304, etc. The flushing management logic 560 determines whether the degree (M) of nozzle defects satisfies the flushing quality criteria 562, such as by comparing the degree (M) of nozzle defects to a notification threshold (TH1) specified in the flushing quality criteria 562 (step 922). When the degree (M) of nozzle defects does not exceed the notification threshold (TH1), the process returns to monitoring nozzle defects (step 910). When the degree (M) of nozzle defects exceeds the notification threshold (TH1), the flushing management logic 560 initiates a corrective action of issuing, displaying, or otherwise providing a notification 514 (step 924), such as to a printer operator 622. In an embodiment, the flushing management logic 560 may issue, display, or otherwise provide a warning that the flushing setting 504 is insufficient, deficient, or inadequate (optional step 926). For example, the flushing management logic 560 may send an instruction or command to the DFE 204 and/or user interface 218 over a communication link 580 to display the warning to the printer operator 622. One technical benefit is the flushing management logic 560 may inform a printer operator 622 or the like of deficient flushing so that the printer operator 622 may adjust the flushing setting 504 accordingly, which helps to prevent print quality from being negatively affected by nozzle defects. Printer operators 622 may be expected to select the least aggressive flushing setting 504 that is safe in order to reduce the amount of flushed ink while preserving operability. Rapid feedback to printer operators 622, such as when they have selected an inappropriate or insufficient flushing setting 504, will assist the printer operators 622 to become proficient in finding the best flushing setting 504 and in minimizing perceived print quality problems. In an embodiment, the flushing management logic 560 may issue, display, or otherwise provide a recommendation of an adjustment to the flushing setting 504 (optional step 928). For example, the flushing management logic 560 may send an instruction or command to the DFE 204 and/or user interface 218 over a communication link 580 to display the recommendation to the printer operator 622. Assume, for example, that the present flushing setting 504 (determined to be inadequate) is a thin line setting of “light”. The recommendation from the flushing management logic 560 may be to increase the flushing setting 504 to a thin line setting of “medium”, “heavy”, or “very heavy”. The recommendation may be based on a lookup table, may be based on an amount (e.g., number, rate, etc.) that the degree (M) of nozzle defects exceeds the notification threshold, etc. One technical benefit is the printer operator 622 can adjust the flushing setting 504 based on the recommendation from the flushing management logic 560.

FIG. 9B illustrates a method 930 where the flushing management logic 560 generates an abort signal 516 when a degree of nozzle defects becomes excessive according to the flushing quality criteria 562 (i.e., exceeds a threshold). Functions of the flushing management logic 560 that overlap with method 900 are illustrated with like reference numbers. Again, one assumption is that the image forming apparatus 102 performs a print operation for one or more print jobs 211. During or between print operations, the flushing control logic 550 performs, initiates, or controls one or more flushing operations 400 according to the flushing setting 504 presently selected from the variable flushing settings 504.

After one or more instances or occurrences of the flushing operation 400, the flushing management logic 560 performs or initiates a flushing quality check 510 (step 908). For the flushing quality check 510, the flushing management logic 560 monitors nozzle defects of the nozzles 306 of the printhead(s) 304 in jetting (step 910). For example, the flushing management logic 560 may receive nozzle defect data 520 from a nozzle inspection system 564 or the like (step 912), and process the nozzle defect data 520 to identify nozzle defects that are detected (step 914). The flushing management logic 560 computes, calculates, or determines a degree (M) of nozzle defects (step 916). The flushing management logic 560 determines whether the degree (M) of nozzle defects satisfies the flushing quality criteria 562, such as by comparing the degree (M) of nozzle defects to an abort threshold (TH2) specified in the flushing quality criteria 562 (step 932). When the degree (M) of nozzle defects does not exceed the abort threshold (TH2), the process returns to monitoring nozzle defects (step 910). When the degree (M) of nozzle defects exceeds the abort threshold (TH2), the flushing management logic 560 initiates a corrective action of providing or issuing an abort signal 516 to abort a printing operation (step 934). For example, the flushing management logic 560 may send the abort signal 516 (also referred to as an instruction or command) to the DFE 204, print controller 214, print engine(s) 220, etc., over a communication link 580 to abort a printing operation. One technical benefit is the flushing management logic 560 may stop printing when the flushing setting 504 is inadequate, such as to avoid wasting resources (e.g., print liquid 234, printable medium 232, etc.) when print quality is assumed to be low.

FIG. 9C illustrates a method 960 where the flushing management logic 560 performs a setting adjustment 518 when a degree of nozzle defects becomes excessive according to the flushing quality criteria 562 (i.e., exceeds a threshold). Functions of the flushing management logic 560 that overlap with methods 900/930 are illustrated with like reference numbers. Again, one assumption is that the image forming apparatus 102 performs a print operation for one or more print jobs 211. During or between print operations, the flushing control logic 550 performs, initiates, or controls one or more flushing operations 400 according to the flushing setting 504 presently selected from the variable flushing settings 504.

After one or more instances or occurrences of the flushing operation 400, the flushing management logic 560 performs or initiates a flushing quality check 510 (step 908). For the flushing quality check 510, the flushing management logic 560 monitors nozzle defects of the nozzles 306 of the printhead(s) 304 in jetting (step 910). For example, the flushing management logic 560 may receive nozzle defect data 520 from a nozzle inspection system 564 or the like (step 912), and process the nozzle defect data 520 to identify nozzle defects that are detected (step 914). The flushing management logic 560 computes, calculates, or determines a degree (M) of nozzle defects (step 916). The flushing management logic 560 determines whether the degree (M) of nozzle defects satisfies the flushing quality criteria 562, such as by comparing the degree (M) of nozzle defects to a setting adjustment threshold (TH3) specified in the flushing quality criteria 562 (step 962). When the degree (M) of nozzle defects does not exceed the setting adjustment threshold (TH3), the process returns to monitoring nozzle defects (step 910). When the degree (M) of nozzle defects exceeds the setting adjustment threshold (TH3), the flushing management logic 560 initiates a corrective action of adjusting (e.g., automatically) the flushing setting 504 for the flushing operation 400 (step 964). For example, the flushing management logic 560 may send an instruction or command to the DFE 204 and/or the flushing control logic 550 over a communication link 580 to adjust, change, or modify the current flushing setting 504. One technical benefit is the flushing management logic 560 may automatically adjust the flushing setting 504 to avoid print quality being negatively affected by nozzle defects. After adjusting the flushing setting 504, the flushing management logic 560 may issue, display, or otherwise provide a notification indicating the adjustment to the flushing setting 504 (optional step 966). For example, the flushing management logic 560 may send an instruction or command to the DFE 204 and/or user interface 218 over a communication link 580 to display the notification to the printer operator 622. The printer operator 622 may therefore learn from the adjustments made to the flushing setting 504 by the flushing management logic 560, such as for future settings.

The flushing management logic 560 may initiate adjusting the flushing setting 504 in a variety of ways, which may be specified (e.g., pre-configured) in the flushing quality criteria 562, or configurable for flushing operations 400. FIG. 9D illustrates details of adjusting a flushing setting (step 964) shown in method 960. In FIG. 9D, for example, the flushing management logic 560 may automatically increase a flushing amount 552 for the flushing operation 400 (step 968). For example, the current flushing setting 504 may be configured to jet a certain number of droplets of print liquid 234 from nozzles 306, to jet one of a plurality of predetermined droplet sizes of print liquid 234 from nozzles 306, to jet one of a plurality of frequencies (e.g., flushing operation per interval such as time, length, sheets, etc.) of droplets of print liquid 234 from nozzles 306, to jet at a jetting velocity, etc., referred to as a flushing amount 552. The flushing management logic 560 may automatically increase the flushing amount 552 for the flushing operation 400 when the degree (M) of nozzle defects exceeds the setting adjustment threshold (TH3). In an embodiment, the flushing management logic 560 may automatically increase the flushing setting 504 (step 970). As illustrated in FIGS. 7A-7B, the flushing settings 504 may comprise increasing density levels 702 for flush marks 404. In an embodiment, the flushing management logic 560 may automatically increase the flushing setting 504 by one density level 702 (optional step 972), such as from “light” to “medium”, from “medium” to “heavy”, etc. One technical benefit is the adjustment may be made in small intervals or increments that avoid excessive adjustment increments that would otherwise waste flushing ink. In an embodiment, the flushing management logic 560 may automatically increase the flushing setting 504 by one or more density levels 702 (optional step 974). In an example, the flushing management logic 560 may automatically increase the flushing setting 504 based on an amount that the degree (M) of nozzle defects exceeds the setting adjustment threshold. For instance, when the degree (M) of nozzle defects exceeds the setting adjustment threshold by a first predetermined amount, the flushing management logic 560 may automatically increase the flushing setting 504 by one density level 702, such as from “light” to “medium”, from “medium” to “heavy”, etc. When the degree (M) of nozzle defects exceeds the setting adjustment threshold by a second predetermined amount larger than the first predetermined amount, the flushing management logic 560 may automatically increase the flushing setting 504 by more than one density level 702, such as from “light” to “heavy”. One technical benefit is the adjustments may be made in larger intervals or increments to more effectively address the larger degree deviations. In another example, the flushing management logic 560 may automatically increase the flushing setting 504 by one or more density levels 702 based on a remaining length or remaining number of sheets of printable medium 232 in an observation window.

As illustrated in FIG. 6, the flushing settings 504 may be classified by flushing type 604. In an embodiment, the flushing management logic 560 may automatically increase the flushing setting 504 (exclusively) within the flushing type 604 (optional step 976). For example, when the flushing setting 504 is a line flushing type 606, the flushing management logic 560 may automatically increase the flushing setting 504 within the line flushing type 606. When the flushing setting 504 is a star flushing type 608, the flushing management logic 560 may automatically increase the flushing setting 504 within the star flushing type 608. One technical benefit for increasing the flushing setting 504 within a type, is to minimize the perception of the flush setting adjustments.

In embodiments described herein, the flushing settings 504 may be defined in a granular level for flushing operations 400 within the image forming apparatus 102. Flushing management logic 560 may adjust the flushing setting on a per section (e.g., per printhead, per printhead array, per color plane, per region, etc.) basis. In an example, the flushing settings 504 may be defined per color plane 320 supported by the image forming apparatus 102. Thus, the flushing management logic 560 may adjust (e.g., automatically) the flushing setting 504 per color plane 320 or on a per color plane basis (step 978). In another example, the flushing settings 504 may be defined per printhead 304 or per printhead array 302 within the image forming apparatus 102. Thus, the flushing management logic 560 may adjust (e.g., automatically) the flushing setting 504 per printhead 304 (or on a per printhead basis), may adjust (e.g., automatically) the flushing setting 504 per printhead array 302 (or on a per array basis), etc. (step 980). In another embodiment, the flushing settings 504 may be defined per individual nozzle 306 or regions 322 of a printhead(s) 304 within the image forming apparatus 102 (see also, FIG. 3). Thus, the flushing management logic 560 may adjust (e.g., automatically) the flushing setting 504 per region 322 (e.g., column region) or on a per region basis (step 982). A column region, for example, is a region of a print mechanism 226 where nozzles 306 of printheads 304 are aligned in a conveyance direction 324 of the printable medium 232. In another embodiment, flushing management logic 560 may perform flushing quality checks (e.g., methods 800, 900, 930, 960, 1200, 1220, 1240, 1300, 1320, and/or 1340) on a per section basis. In other words, the flushing quality check process is performed with nozzle defect data sorted and analyzed according to corresponding sections. One resulting technical benefit for initiating flushing setting changes on a per section basis (e.g., the printhead, printhead array, color plane, region, etc.) for the image forming apparatus 102, is the ability to provide precise responses and avoid the inaccuracies of broader system-wide evaluations.

Although some examples were described above, the flushing management logic 560 may adjust the flushing setting 504 in other ways.

The flushing management logic 560 may perform one or multiple ones of the flushing quality checks 510 described above. In other words, the flushing management logic 560 may perform a combination of any one or more of methods 900, 930, and 960. For example, the flushing management logic 560 may be configured with one or more of the thresholds described above (e.g., notification threshold (TH1), abort threshold (TH2), and setting adjustment threshold (TH3)). At any given instance, the flushing management logic 560 may be enabled to perform a flushing quality check 510 based on the notification threshold (TH1), abort threshold (TH2), and setting adjustment threshold (TH3) alone. In other instances, the flushing management logic 560 may be enabled to perform a flushing quality check 510 based on a combination of the thresholds, such as the notification threshold (TH1) and the abort threshold (TH2), the setting adjustment threshold (TH3) and the abort threshold (TH2), the notification threshold (TH1) and setting adjustment threshold (TH3), etc. When a combination of the thresholds is enabled, it is assumed that the thresholds are different so as to trigger different corrective actions 512. The resulting technical benefit is providing one or more corrective actions 512 for the monitored nozzle defects based on different thresholds.

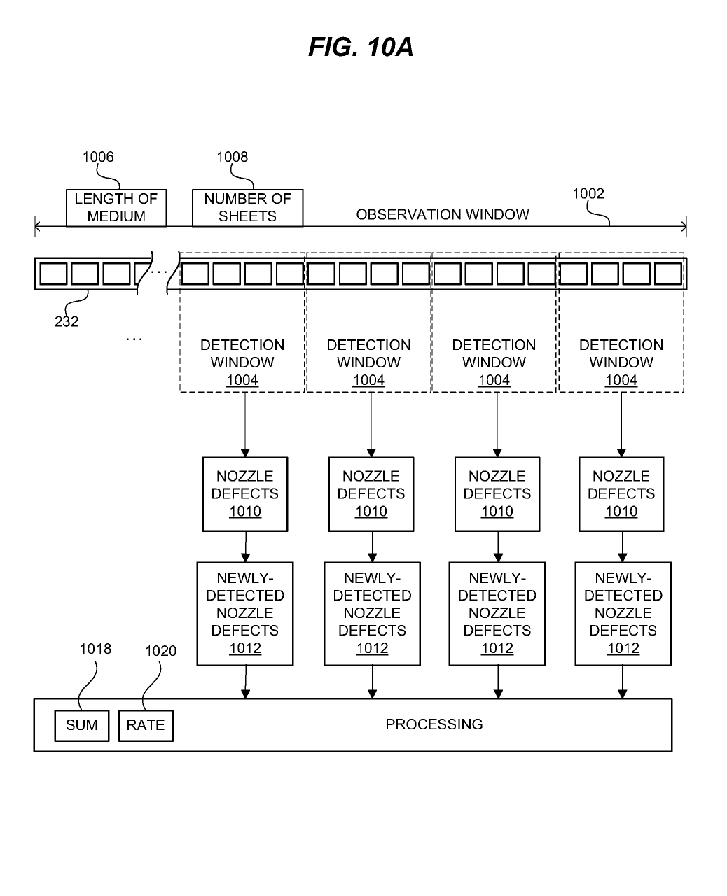

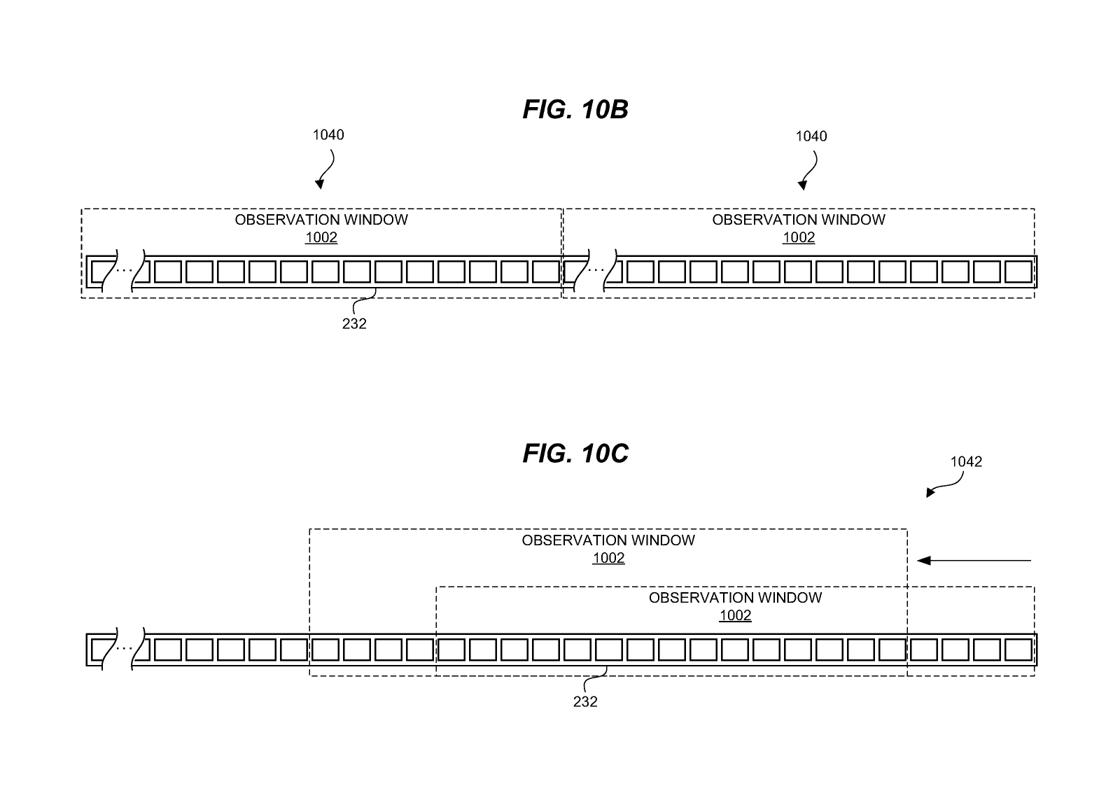

FIGS. 10A-10C are block diagrams illustrating flushing quality checks 510 in illustrative embodiments. In FIG. 10A, the flushing management logic 560 may perform a flushing quality check 510 over a length 1006 of printable medium 232 (i.e., in continuous-form printing) or a number of sheets 1008 of printable medium 232 (i.e., physical sheets in cut-sheet printing or logical sheets in continuous forms printing) referred to as an observation window 1002. Within the observation window 1002, the flushing management logic 560 processes data in smaller intervals referred to as detection windows 1004. Therefore, a detection window 1004 is a length 1006 of printable medium 232 or a number of sheets 1008 of printable medium 232 smaller than the observation window 1002. For example, an observation window 1002 may be one hundred meters of printable medium 232 or one hundred sheets, and a detection window 1004 may be one meter of printable medium 232 or four sheets. The detection windows 1004 may be discontinuous lengths or non-consecutive sheets of printable medium 232.

While an image forming apparatus 102 prints on the printable medium 232 with the printhead(s) 304, the flushing management logic 560 may receive nozzle defect data 520 indicating nozzle defects 1010 within a detection window 1004. Based on the nozzle defects 1010 indicated in the nozzle defect data 520, the flushing management logic 560 is able to extract or identify newly-detected nozzle defects 1012 that were detected in the current detection window 1004. For example, the nozzle defects 1010 for a particular detection window 1004 may indicate that nozzle-2 and nozzle-5 are experiencing defects. The nozzle defects 1010 for a next detection window 1004 may indicate that nozzle-2, nozzle-5, and nozzle-192 are experiencing defects. Thus, the flushing management logic 560 is able to identify that nozzle-192 is experiencing a newly-detected defect in the current detection window 1004. The newly-detected nozzle defects 1012 are therefore identified over a plurality of successive detection windows 1004.

The flushing management logic 560 may process or monitor the newly-detected nozzle defects 1012 to determine whether or not to take a corrective action 512. For example, when the selected flushing setting 504 is too low, the newly-detected nozzle defects 1012 may accumulate during printing. Thus, the flushing management logic 560 may compute a quantity or sum 1018 of the newly-detected nozzle defects 1012, and compare the sum 1018 to a threshold(s). The sum 1018 therefore represents a degree of nozzle defects in one embodiment. In another example, when the selected flushing setting 504 is too low, the newly-detected nozzle defects 1012 may appear at a higher-than-normal rate during printing. Thus, the flushing management logic 560 may compute a rate 1020 of the newly-detected nozzle defects 1012 (i.e., a rate of nozzle defect formation), and compare the rate 1020 to a threshold(s). The rate 1020 therefore represents a degree of nozzle defects in another embodiment.

In embodiments described herein, the observation window 1002 may be a fixed window or a sliding window. FIG. 10B, for example, shows the observation window 1002 as a fixed observation window 1040. In this example, the flushing management logic 560 processes or monitors newly-detected nozzle defects 1012 over a fixed observation window 1040 of a length 1006 of printable medium 232 or number of sheets 1008 of printable medium 232. FIG. 10C, for example, shows the observation window 1002 as a sliding observation window 1042. In this example, the flushing management logic 560 processes or monitors newly-detected nozzle defects 1012 over the sliding observation window 1042 of a length 1006 of printable medium 232 or number of sheets 1008 of printable medium 232.

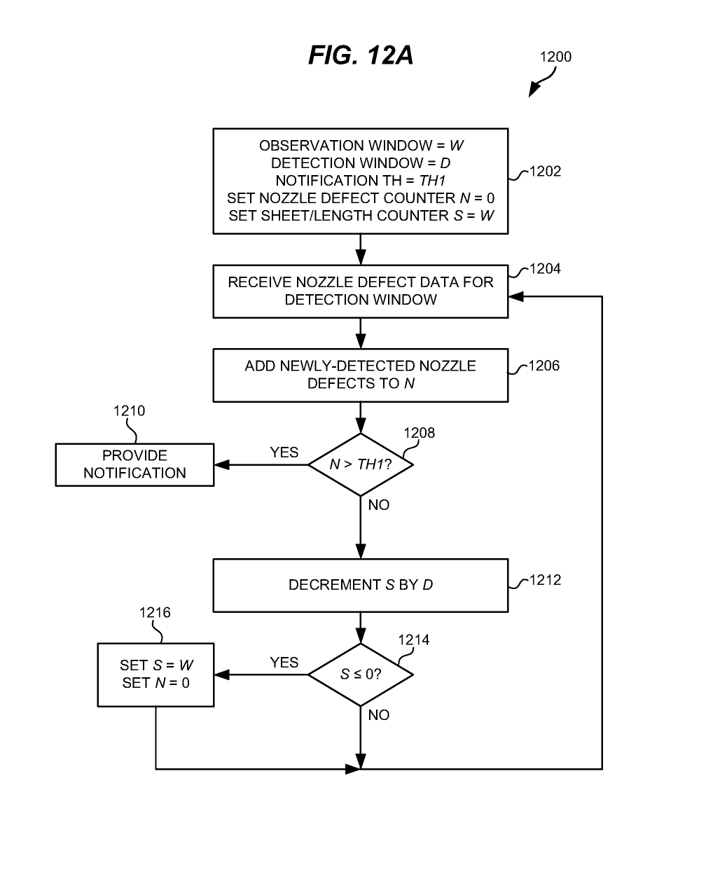

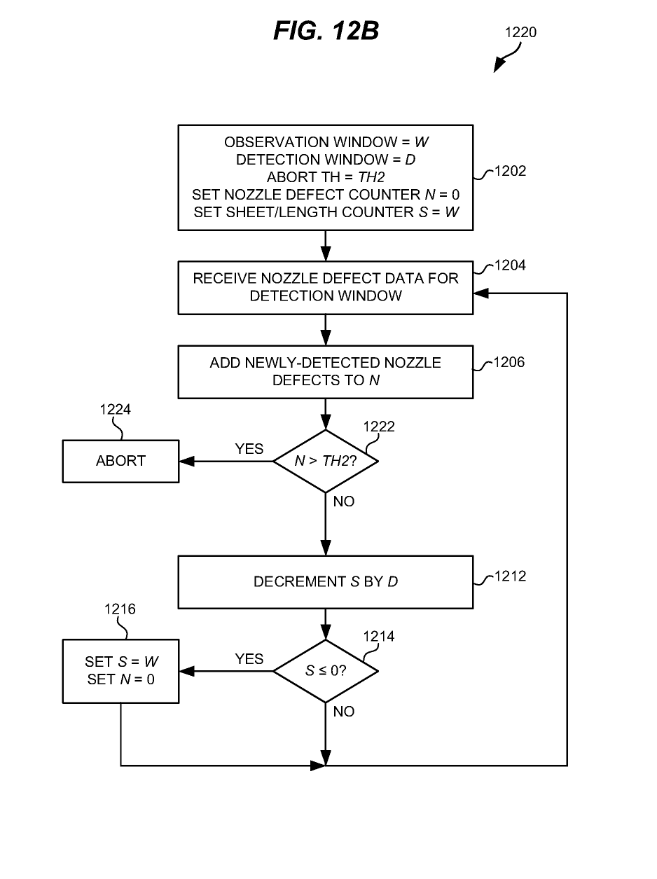

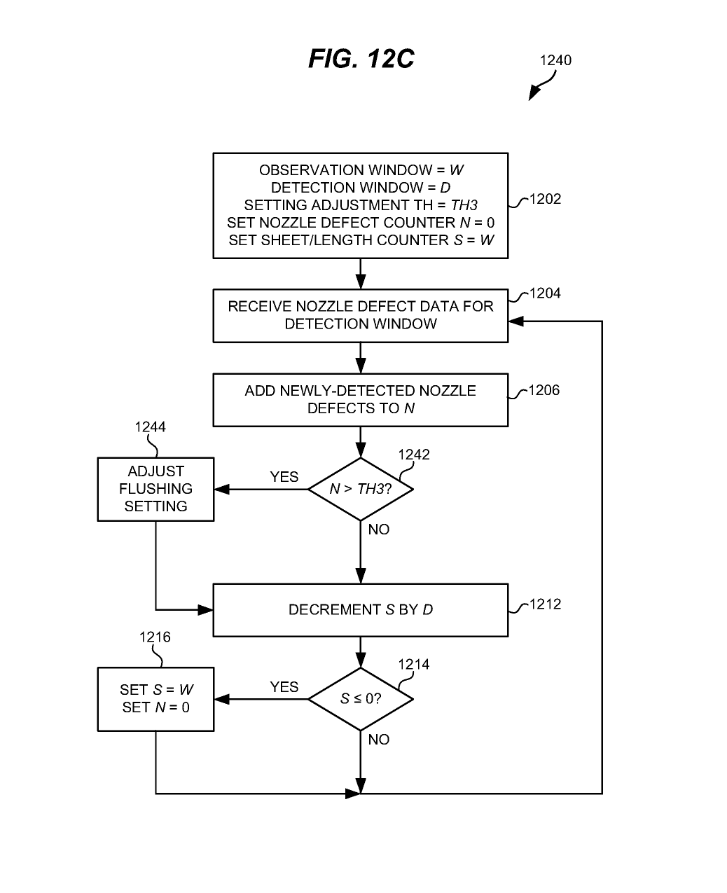

FIGS. 12A-12C are flow charts illustrating methods 1200/1220/1240 of performing flushing quality checks 510 in illustrative embodiments. The examples in FIGS. 12A-12C are for a fixed observation window 1040. The flushing quality check 510 in the flushing management logic 560 may be enabled or disabled. In FIG. 12A, it is assumed that the flushing quality check 510 is enabled to generate a notification 514. When enabled for a fixed observation window 1040, the flushing management logic 560 identifies or sets a variety of parameters for the fixed observation window 1040. For example, the flushing management logic 560 identifies or sets a size value (e.g., W) for the fixed observation window 1040, identifies or sets a size value (e.g., D) for a detection window 1004 within the fixed observation window 1040, and identifies the notification threshold (e.g., TH1), as in step 1202. The flushing management logic 560 also initializes a nozzle defect counter (e.g., N) and a sheet/length counter (e.g., S) by setting the nozzle defect counter (e.g., N) to an initial value (e.g., “0”), and the sheet/length counter (e.g., S) equal to the size value (e.g., W) for the fixed observation window 1040.

The flushing management logic 560 receives nozzle defect data 520 for the current detection window 1004 (step 1204). For example, if the current detection window 1004 is one meter of printable medium 232, then the nozzle defect data 520 indicates nozzle defects 1010 detected when printing on at least a portion of that one meter of printable medium 232. The flushing management logic 560 may process the nozzle defect data 520 to identify any newly-detected nozzle defects 1012 in the current detection window 1004. For example, for a first detection window 1004 in the fixed observation window 1040, each of the nozzle defects 1010 may be considered newly-detected nozzle defects 1012. For the next successive detection window 1004 in the fixed observation window 1040, the flushing management logic 560 may compare nozzle defects 1010 for the current detection window 1004 with nozzle defects 1010 in a prior detection window(s) 1004 (e.g., the first detection window 1004) to identify any newly-detected nozzle defects 1012 in the current detection window 1004. Alternatively, the nozzle defect data 520 received from the nozzle inspection system 564 or from an intermediary device/system may indicate the newly-detected nozzle defects 1012.

The flushing management logic 560 adds the number of newly-detected nozzle defects 1012 to the nozzle defect counter (e.g., N), as in step 1206. Thus, the nozzle defect counter is a running tally of newly-detected nozzle defects 1012 found in each successive detection window 1004. The flushing management logic 560 compares the nozzle defect counter (e.g., N) to the notification threshold (TH1) to determine whether the nozzle defect counter exceeds the notification threshold (TH1) (step 1208). When the nozzle defect counter exceeds the notification threshold (TH1), the flushing management logic 560 provides (e.g., displays) a notification 514 (step 1210), such as a warning that the current flushing setting 504 is insufficient. After providing the notification 514, the flushing quality check 510 may be disabled. When the nozzle defect counter does not exceed the notification threshold (TH1), the flushing management logic 560 decrements the sheet/length counter (e.g., S) by the size value (e.g., D) for the detection window 1004 (step 1212). The sheet/length counter (e.g., S) indicates whether or not the end of the fixed observation window 1040 has been reached with the present detection window 1004. Thus, the flushing management logic 560 determines whether the sheet/length counter (e.g., S) is greater than or equal to “0” (step 1214). When the end of the fixed observation window 1040 has been reached, the flushing management logic 560 reinitializes the parameters for the next fixed observation window 1040 (i.e., set S = W, and N = 0) as in step 1216, and processing returns to step 1204. When the end of the fixed observation window 1040 has not been reached, processing returns to step 1204. One technical benefit is the flushing management logic 560 may inform a printer operator 622 or the like of deficient flushing so that the printer operator 622 may adjust the flushing setting 504 accordingly, which results in improved print quality.

FIG. 12B illustrates an alternative method 1220 where a printing operation is aborted based on the nozzle defect data 520. It is assumed in this example that the flushing quality check 510 is enabled to provide an abort signal 516 to abort a printing operation. Processing is similar as described in FIG. 12A, where the flushing management logic 560 identifies or sets a variety of parameters for the fixed observation window 1040, such as identifying the abort threshold (e.g., TH2), as in step 1202. The flushing management logic 560 receives nozzle defect data 520 for the current detection window 1004 (step 1204), and adds the number of newly-detected nozzle defects 1012 to the nozzle defect counter (e.g., N), as in step 1206.

The flushing management logic 560 compares the nozzle defect counter (e.g., N) to the abort threshold (TH2) to determine whether the nozzle defect counter exceeds the abort threshold (TH2) (step 1222). When the nozzle defect counter exceeds the abort threshold (TH2), the flushing management logic 560 generates an abort signal 516 to abort a printing operation (step 1224). After aborting the print operation, the flushing quality check 510 may be disabled. When the nozzle defect counter does not exceed the abort threshold (TH2), the flushing management logic 560 decrements the sheet/length counter (e.g., S) by the size value (e.g., D) for the detection window 1004 (step 1212). The flushing management logic 560 determines whether the sheet/length counter (e.g., S) is greater than or equal to “0” (step 1214). When the end of the fixed observation window 1040 has been reached, the flushing management logic 560 reinitializes the parameters for the next fixed observation window 1040 (i.e., set S = W, and N = 0) as in step 1216, and processing returns to step 1204. When the end of the fixed observation window 1040 has not been reached, processing returns to step 1204. One technical benefit is the flushing management logic 560 may stop printing when the flushing setting 504 is inadequate, such as to avoid wasting resources when print quality is assumed to be low.

FIG. 12C illustrates an alternative method 1240 where the flushing management logic 560 adjusts (e.g., automatically) the flushing setting 504 based on the nozzle defect data 520. It is assumed in this example that the flushing quality check 510 is enabled for setting adjustment 518. Processing is similar as described in FIGS. 12A and 12B, where the flushing management logic 560 identifies or sets a variety of parameters for the fixed observation window 1040, such as identifying the setting adjustment threshold (e.g., TH3), as in step 1202. The flushing management logic 560 receives nozzle defect data 520 for the current detection window 1004 (step 1204), and adds the number of newly-detected nozzle defects 1012 to the nozzle defect counter (e.g., N), as in step 1206.

The flushing management logic 560 compares the nozzle defect counter (e.g., N) to the setting adjustment threshold (TH3) to determine whether the nozzle defect counter exceeds the setting adjustment threshold (TH3) (step 1242). When the nozzle defect counter exceeds the setting adjustment threshold (TH3), the flushing management logic 560 adjusts (e.g., automatically) the flushing setting 504 (step 1244). The flushing management logic 560 decrements the sheet/length counter (e.g., S) by the size value (e.g., D) for the detection window 1004 (step 1212). The flushing management logic 560 determines whether the sheet/length counter (e.g., S) is greater than or equal to “0” (step 1214). When the end of the fixed observation window 1040 has been reached, the flushing management logic 560 reinitializes the parameters for the next fixed observation window 1040 (i.e., set S = W, and N = 0) as in step 1216, and processing returns to step 1204. When the end of the fixed observation window 1040 has not been reached, processing returns to step 1204. One technical benefit is the flushing management logic 560 may automatically adjust the flushing setting 504 to improve print quality.

As above, the flushing management logic 560 may perform one or multiple ones of the flushing quality checks 510 described above.

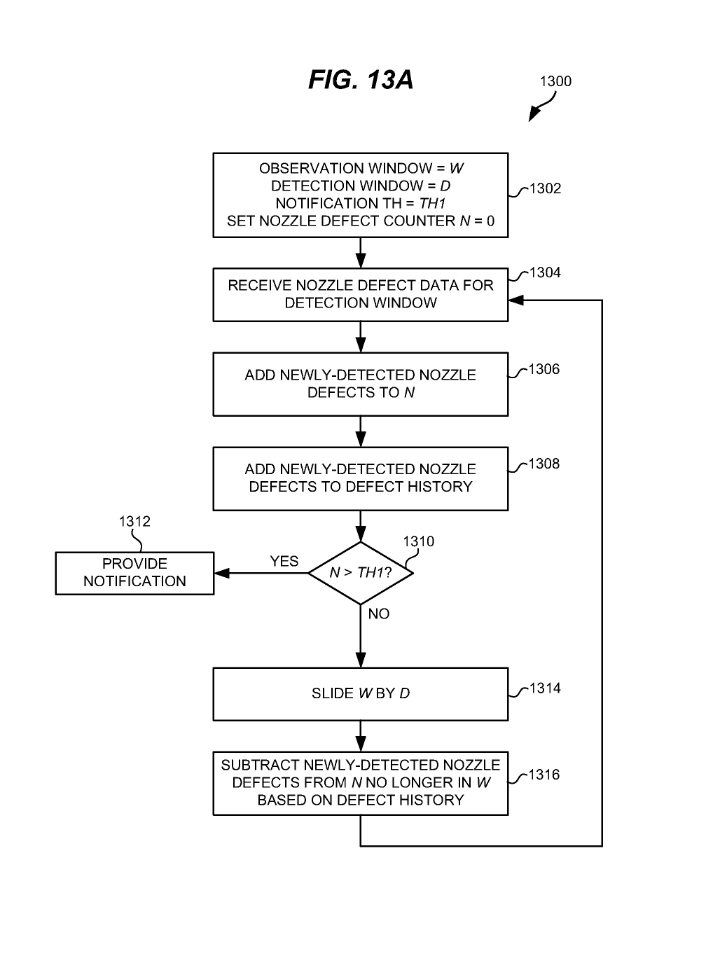

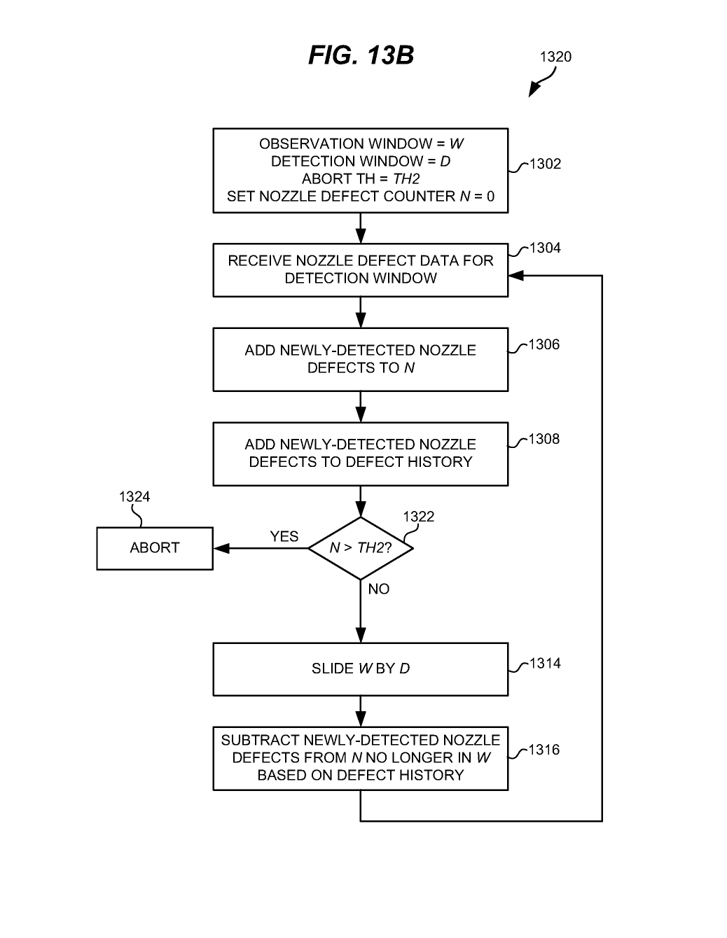

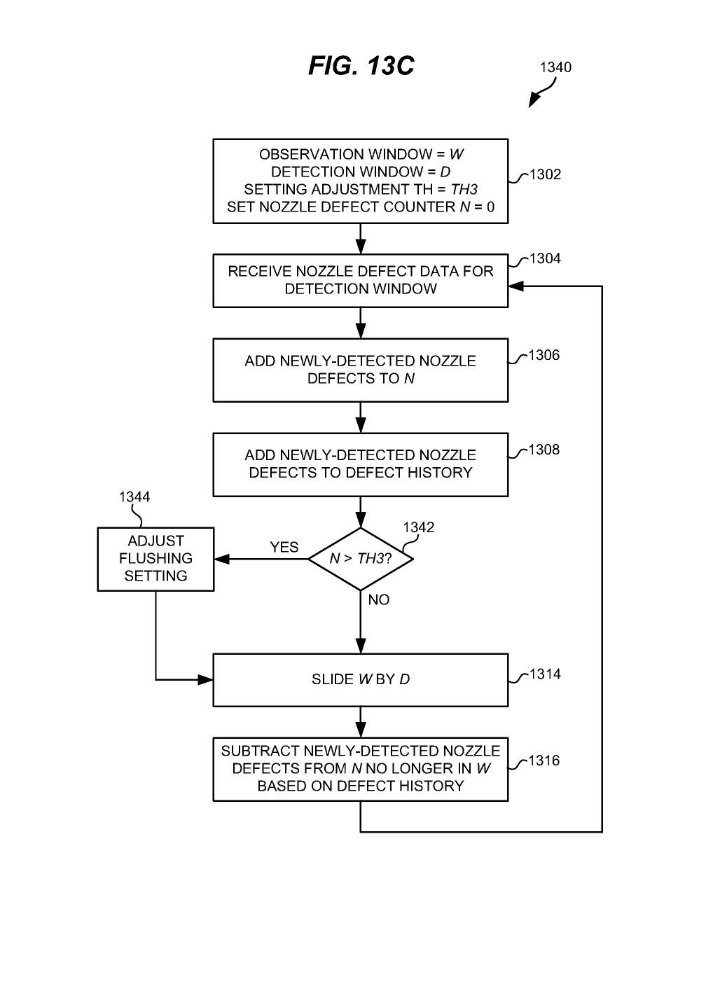

FIGS. 13A-13C are flow charts illustrating methods 1300/1320/1340 of performing flushing quality checks 510 in illustrative embodiments. The examples in FIGS. 13A-13C are for a sliding observation window 1042. In FIG. 13A, it is assumed that the flushing quality check 510 is enabled to generate a notification 514. When enabled for a sliding observation window 1042, the flushing management logic 560 identifies or sets a variety of parameters for the sliding observation window 1042. For example, the flushing management logic 560 identifies or sets a size value (e.g., W) for the sliding observation window 1042, identifies or sets a size value (e.g., D) for a detection window 1004 within the sliding observation window 1042, and identifies the notification threshold (e.g., TH1), as in step 1302. The flushing management logic 560 also initializes a nozzle defect counter (e.g., N) by setting the nozzle defect counter (e.g., N) to an initial value (e.g., “0”).

The flushing management logic 560 receives nozzle defect data 520 for the current detection window 1004 (step 1304). The flushing management logic 560 may process the nozzle defect data 520 to identify any newly-detected nozzle defects 1012 in the current detection window 1004, and adds the number of newly-detected nozzle defects 1012 to the nozzle defect counter (e.g., N), as in step 1306. Thus, the nozzle defect counter is a running tally of newly-detected nozzle defects 1012 found in each successive detection window 1004. Because a sliding observation window 1042 is used, the flushing management logic 560 maintains a defect history that contains data for the sliding observation window 1042. The flushing management logic 560 adds the newly-detected nozzle defects 1012 for the current detection window 1004 to the defect history (step 1308).

The flushing management logic 560 compares the nozzle defect counter (e.g., N) to the notification threshold (TH1) to determine whether the nozzle defect counter exceeds the notification threshold (TH1) (step 1310). When the nozzle defect counter exceeds the notification threshold (TH1), the flushing management logic 560 provides (e.g., displays) a notification 514 (step 1312), such as a warning that the current flushing setting 504 is insufficient. After providing the notification 514, the flushing quality check 510 may be disabled. When the nozzle defect counter does not exceed the notification threshold (TH1), the flushing management logic 560 slides or moves the sliding observation window 1042 (e.g., W) by the size value (e.g., D) of the detection windows 1004 (step 1314). For example, if the size value (e.g., D) of a detection window 1004 is one meter, then the flushing management logic 560 slides or moves the sliding observation window 1042 by one meter. The flushing management logic 560 then deletes data from the defect history related to the oldest detection window 1004 no longer in the sliding observation window 1042. More particularly, the flushing management logic 560 subtracts the newly-detected nozzle defects 1012 corresponding with the oldest detection window 1004 and no longer in the sliding observation window 1042, from the nozzle defect counter (step 1316). Processing then returns to step 1304. One technical benefit is the flushing management logic 560 may inform a printer operator 622 or the like of deficient flushing so that the printer operator 622 may adjust the flushing setting 504 accordingly, which results in improved print quality.

FIG. 13B illustrates an alternative method 1320 where a printing operation is aborted based on the nozzle defect data 520. It is assumed in this example that the flushing quality check 510 is enabled to generate an abort signal 516 to abort a printing operation. Processing is similar as described in FIG. 13A, where the flushing management logic 560 identifies or sets a variety of parameters for the sliding observation window 1042, such as identifying the abort threshold (e.g., TH2), as in step 1302. The flushing management logic 560 receives nozzle defect data 520 for the current detection window 1004 (step 1304), adds the number of newly-detected nozzle defects 1012 to the nozzle defect counter (e.g., N) (step 1306), and adds the newly-detected nozzle defects 1012 for the current detection window 1004 to the defect history (step 1308).

The flushing management logic 560 compares the nozzle defect counter (e.g., N) to the abort threshold (TH2) to determine whether the nozzle defect counter exceeds the abort threshold (TH2) (step 1322). When the nozzle defect counter exceeds the abort threshold (TH2), the flushing management logic 560 provides an abort signal 516 to abort a printing operation (step 1324). After aborting the print operation, the flushing quality check 510 may be disabled. When the nozzle defect counter does not exceed the abort threshold (TH2), the flushing management logic 560 slides or moves the sliding observation window 1042 (e.g., W) by the size value (e.g., D) of the detection windows 1004 (step 1314). The flushing management logic 560 then deletes data from the defect history related to the oldest detection window 1004 no longer in the sliding observation window 1042. More particularly, the flushing management logic 560 subtracts the newly-detected nozzle defects 1012 corresponding with the oldest detection window 1004 and no longer in the sliding observation window 1042, from the nozzle defect counter (step 1316). Processing then returns to step 1304. One technical benefit is the flushing management logic 560 may stop printing when the flushing setting 504 is inadequate, such as to avoid wasting resources when print quality is assumed to be low.

FIG. 13C illustrates an alternative method 1340 where the flushing management logic 560 adjusts (e.g., automatically) the flushing setting 504 based on the nozzle defect data 520. It is assumed in this example that the flushing quality check 510 is enabled for setting adjustment 518. Processing is similar as described in FIGS. 13A and 13B, where the flushing management logic 560 identifies or sets a variety of parameters for the fixed observation window 1040, such as identifying the setting adjustment threshold (e.g., TH3), as in step 1302. The flushing management logic 560 receives nozzle defect data 520 for the current detection window 1004 (step 1304), adds the number of newly-detected nozzle defects 1012 to the nozzle defect counter (e.g., N) (step 1306), and adds the newly-detected nozzle defects 1012 for the current detection window 1004 to the defect history (step 1308).

The flushing management logic 560 compares the nozzle defect counter (e.g., N) to the setting adjustment threshold (TH3) to determine whether the nozzle defect counter exceeds the setting adjustment threshold (TH3) (step 1342). When the nozzle defect counter exceeds the setting adjustment threshold (TH3), the flushing management logic 560 adjusts (e.g., automatically) the flushing setting 504 (step 1344). The flushing management logic 560 slides or moves the sliding observation window 1042 (e.g., W) by the size value (e.g., D) of the detection windows 1004 (step 1314). The flushing management logic 560 then deletes data from the defect history related to the oldest detection window 1004 no longer in the sliding observation window 1042. More particularly, the flushing management logic 560 subtracts the newly-detected nozzle defects 1012 corresponding with the oldest detection window 1004 and no longer in the sliding observation window 1042, from the nozzle defect counter (step 1316). Processing then returns to step 1304. One technical benefit is the flushing management logic 560 may automatically adjust the flushing setting 504 to improve print quality.

As above, the flushing management logic 560 may perform one or multiple ones of the flushing quality checks 510 described above.

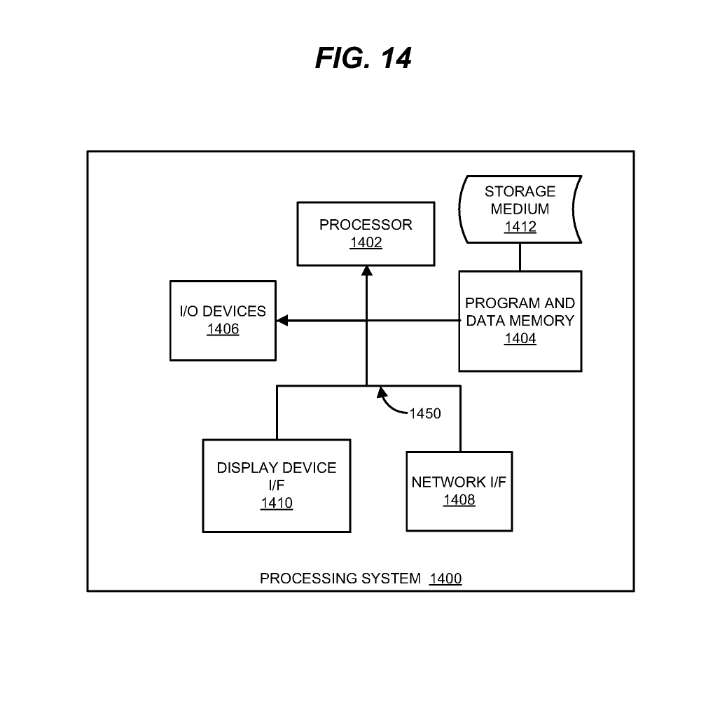

Embodiments disclosed herein can take the form of software, hardware, firmware, or various combinations thereof. FIG. 14 illustrates a processing system 1400 operable to execute a computer readable medium embodying programmed instructions to perform desired functions in an illustrative embodiment. Processing system 1400 is operable to perform the above operations by executing programmed instructions tangibly embodied on computer readable storage medium 1412. In this regard, embodiments can take the form of a computer program accessible via computer-readable medium 1412 providing program code for use by a computer or any other instruction execution system. For the purposes of this description, computer readable storage medium 1412 can be anything that can contain or store the program for use by the computer.

Computer readable storage medium 1412 can be an electronic, magnetic, optical, electromagnetic, infrared, or semiconductor device. Examples of computer readable storage medium 1412 include a solid-state memory, a magnetic tape, a removable computer diskette, a random access memory (RAM), a read-only memory (ROM), a rigid magnetic disk, and an optical disk. Current examples of optical disks include compact disk - read only memory (CD-ROM), compact disk - read/write (CD-R/W), and DVD.

Processing system 1400, being suitable for storing and/or executing the program code, includes at least one processor 1402 coupled to program and data memory 1404 through a system bus 1450. Program and data memory 1404 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1406 (including but not limited to keyboards, displays, pointing devices, etc.) can be coupled either directly or through intervening I/O controllers. Network adapter interfaces 1408 may also be integrated with the system to enable processing system 1400 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1410 may be integrated with the system to interface to one or more display devices, such as printing systems and screens for presentation of data generated by processor 1402.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes an apparatus comprising a flushing quality manager comprising at least one processor and memory. The at least one processor is configured to cause the flushing quality manager at least to perform at least one flushing quality check regarding a flushing operation of nozzles in at least one printhead. The at least one flushing quality check comprises identifying nozzle defects in the nozzles, computing a rate of nozzle defect formation based on the nozzle defects, and initiating a corrective action directed to modifying the flushing operation when the rate of nozzle defect formation exceeds a threshold.

Example 2 includes the subject matter of Example 1, where the initiating of the corrective action comprises increasing a flushing amount when the rate of nozzle defect formation exceeds the threshold.

Example 3 includes the subject matter of Examples 1 and 2, where the flushing operation is performed according to a flushing setting, and the initiating of the corrective action comprises automatically adjusting the flushing setting when the rate of nozzle defect formation exceeds the threshold.

Example 4 includes the subject matter of Examples 1-3, where the automatically adjusting of the flushing setting comprises automatically increasing the flushing setting.

Example5 includes the subject matter of Examples 1-4, where the automatically adjusting of the flushing setting comprises automatically adjusting the flushing setting per color plane.

Example 6 includes the subject matter of Example 1-5, where the automatically adjusting of the flushing setting comprises automatically adjusting the flushing setting per printhead.

Example 7 includes the subject matter of Examples 1-6, where the automatically adjusting of the flushing setting comprises automatically adjusting the flushing setting per region of a print mechanism comprising the at least one printhead.

Example8 includes the subject matter of Examples 1-7, where the flushing operation is performed according to a flushing setting, and the initiating of the corrective action comprises providing a warning indicating the flushing setting is insufficient when the rate of nozzle defect formation exceeds the threshold.

Example 9 includes the subject matter of Examples 1-8, where the flushing operation is performed according to a flushing setting, and the initiating of the corrective action comprises providing a recommendation of an adjustment to the flushing setting when the rate of nozzle defect formation exceeds the threshold.

Example 10 includes the subject matter of Examples 1-9, where the initiating of the corrective action comprises providing an abort signal to abort a printing operation when the rate of nozzle defect formation exceeds the threshold.

Example 11 includes the subject matter of Examples 1-10, and comprises an image forming apparatus comprising the flushing quality manager and the at least one printhead.

Some embodiments pertain to Example 12 that includes a method comprising performing at least one flushing quality check regarding a flushing operation of nozzles in at least one printhead. The performing comprises identifying nozzle defects in the nozzles, computing a rate of nozzle defect formation based on the nozzle defects, and initiating a corrective action directed to modifying the flushing operation when the rate of nozzle defect formation exceeds a threshold.

Example 13 includes the subject matter of Example 12, where the initiating of the corrective action comprises increasing a flushing amount when the rate of nozzle defect formation exceeds the threshold.

Example 14 includes the subject matter of Examples 12 and 13, where the flushing operation is performed according to a flushing setting, and the initiating of the corrective action comprises automatically adjusting the flushing setting when the rate of nozzle defect formation exceeds the threshold.

Example 15 includes the subject matter of Examples 12-14, where the automatically adjusting of the flushing setting comprises automatically increasing the flushing setting.

Example 16 includes the subject matter of Examples 12-15, where the automatically adjusting of the flushing setting comprises automatically adjusting the flushing setting per color plane, per printhead, or per region of a print mechanism comprising the at least one printhead.

Example 17 includes the subject matter of Examples 12-16, where the flushing operation is performed according to a flushing setting, and the initiating of the corrective action comprises providing a warning indicating the flushing setting is insufficient when the rate of nozzle defect formation exceeds the threshold.

Example 18 includes the subject matter of Examples 12-17, where the flushing operation is performed according to a flushing setting, and the initiating of the corrective action comprises providing a recommendation of an adjustment to the flushing setting when the rate of nozzle defect formation exceeds the threshold.

Example 19 includes the subject matter of Examples 12-18, where the initiating of the corrective action comprises providing an abort signal to abort a printing operation when the rate of nozzle defect formation exceeds the threshold.

Some embodiments pertain to Example 20 that includes a non-transitory computer readable medium embodying programmed instructions executed by a processor, where the instructions direct the processor to implement a method comprising performing at least one flushing quality check regarding a flushing operation of nozzles in at least one printhead. The performing comprises identifying nozzle defects in the nozzles, computing a rate of nozzle defect formation based on the nozzle defects, and initiating a corrective action directed to modifying the flushing operation when the rate of nozzle defect formation exceeds a threshold.

Although specific embodiments were described herein, the scope of the invention is not limited to those specific embodiments. The scope of the invention is defined by the following claims and any equivalents thereof.

What is claimed is:

1. An apparatus, comprising:
a flushing quality manager comprising at least one processor and memory;
the at least one processor configured to cause the flushing quality manager at least to:
perform at least one flushing quality check regarding a flushing operation of nozzles in at least one printhead, the at least one flushing quality check comprising:
identifying nozzle defects in the nozzles;
computing a rate of nozzle defect formation based on the nozzle defects; and
initiating a corrective action directed to modifying the flushing operation when the rate of nozzle defect formation exceeds a threshold.

2. The apparatus of claim 1, wherein:
the initiating of the corrective action comprises increasing a flushing amount when the rate of nozzle defect formation exceeds the threshold.

3. The apparatus of claim 1, wherein:
the flushing operation is performed according to a flushing setting; and
the initiating of the corrective action comprises automatically adjusting the flushing setting when the rate of nozzle defect formation exceeds the threshold.

4. The apparatus of claim 3, wherein:
the automatically adjusting of the flushing setting comprises automatically increasing the flushing setting.

5. The apparatus of claim 3, wherein:
the automatically adjusting of the flushing setting comprises automatically adjusting the flushing setting per color plane.

6. The apparatus of claim 3, wherein:
the automatically adjusting of the flushing setting comprises automatically adjusting the flushing setting per printhead.

7. The apparatus of claim 3, wherein:
the automatically adjusting of the flushing setting comprises automatically adjusting the flushing setting per region of a print mechanism comprising the at least one printhead.

8. The apparatus of claim 1, wherein:
the flushing operation is performed according to a flushing setting; and
the initiating of the corrective action comprises providing a warning indicating the flushing setting is insufficient when the rate of nozzle defect formation exceeds the threshold.

9. The apparatus of claim 1, wherein:
the flushing operation is performed according to a flushing setting; and
the initiating of the corrective action comprises providing a recommendation of an adjustment to the flushing setting when the rate of nozzle defect formation exceeds the threshold.

10. The apparatus of claim 1, wherein:
the initiating of the corrective action comprises providing an abort signal to abort a printing operation when the rate of nozzle defect formation exceeds the threshold.

11. An image forming apparatus, comprising:
the flushing quality manager of claim 1; and
the at least one printhead of claim 1.

12. A method comprising:
performing at least one flushing quality check regarding a flushing operation of nozzles in at least one printhead, the performing comprising:
identifying nozzle defects in the nozzles;
computing a rate of nozzle defect formation based on the nozzle defects; and
initiating a corrective action directed to modifying the flushing operation when the rate of nozzle defect formation exceeds a threshold.

13. The method of claim 12, wherein:
the initiating of the corrective action comprises increasing a flushing amount when the rate of nozzle defect formation exceeds the threshold.

14. The method of claim 12, wherein:
the flushing operation is performed according to a flushing setting; and
the initiating of the corrective action comprises automatically adjusting the flushing setting when the rate of nozzle defect formation exceeds the threshold.

15. The method of claim 14, wherein:
the automatically adjusting of the flushing setting comprises automatically increasing the flushing setting.

16. The method of claim 14, wherein:
the automatically adjusting of the flushing setting comprises automatically adjusting the flushing setting per color plane, per printhead, or per region of a print mechanism comprising the at least one printhead.

17. The method of claim 12, wherein:
the flushing operation is performed according to a flushing setting; and
the initiating of the corrective action comprises providing a warning indicating the flushing setting is insufficient when the rate of nozzle defect formation exceeds the threshold.

18. The method of claim 12, wherein:
the flushing operation is performed according to a flushing setting; and
the initiating of the corrective action comprises providing a recommendation of an adjustment to the flushing setting when the rate of nozzle defect formation exceeds the threshold.

19. The method of claim 12, wherein:
the initiating of the corrective action comprises providing an abort signal to abort a printing operation when the rate of nozzle defect formation exceeds the threshold.

20. A non-transitory computer readable medium embodying programmed instructions executed by a processor, wherein the instructions direct the processor to implement a method comprising:
performing at least one flushing quality check regarding a flushing operation of nozzles in at least one printhead, the performing comprising:
identifying nozzle defects in the nozzles;
computing a rate of nozzle defect formation based on the nozzle defects; and
initiating a corrective action directed to modifying the flushing operation when the rate of nozzle defect formation exceeds a threshold.
